(19) United States
(12) Patent Application Publication
(10) Pub. No.: US 2025/0358820 A1
(43) Pub. Date: Nov. 20, 2025

(54) UE-INITIATED TRANSMISSIONS

(71) Applicant: Samsung Electronics Co., Ltd., Suwon-si (KR)

(72) Inventors: Emad Nader Farag, Flanders, NJ (US); Aristides Papasakellariou, Houston, TX (US); Carmela Cozzo, San Diego, CA (US)

(21) Appl. No.: 19/199,356

(22) Filed: May 5, 2025

Related U.S. Application Data
(60) Provisional application No. 63/649,752, filed on May 20, 2024.
(60) Provisional application No. 63/679,395, filed on Aug. 5, 2024.

(51) Int. Cl. H04W 72/21; H04L 1/08; H04W 72/232

(52) U.S. Cl. CPC H04W 72/21; H04L 1/08; H04W 72/232

(57) ABSTRACT

Apparatuses and methods for user equipment (UE) initiated transmissions in a wireless communication system. A method of operating a UE includes receiving first information for resources related to a first transmission, receiving second information for multiple resource configurations related to a second transmission, and determining a first resource configuration from the multiple resource configurations. The method further includes transmitting the first transmission indicating the first resource configuration of the second transmission, transmitting the second transmission, when the second transmission is successfully decoded at a base station (BS), receiving a first signal that includes a first uplink (UL) grant for a third transmission, and transmitting the third transmission based on the first UL grant.

### CROSS-REFERENCE TO RELATED APPLICATIONS AND CLAIM OF PRIORITY

The present application claims priority to U.S. Provisional Patent Application No. 63/649,752, filed on May 20, 2024, and U.S. Provisional Patent Application No. 63/679,395, filed on Aug. 5, 2024. The contents of the above-identified patent documents are incorporated herein by reference.

### TECHNICAL FIELD

The present disclosure relates generally to wireless communication systems and, more specifically, the present disclosure relates to user equipment (UE) initiated transmissions in a wireless communication system.

### BACKGROUND

5th generation (5G) or new radio (NR) mobile communications is recently gathering increased momentum with all the worldwide technical activities on the various candidate technologies from industry and academia. The candidate enablers for the 5G/NR mobile communications include massive antenna technologies, from cellular frequency bands up to high frequencies, to provide beamforming gain and support increased capacity, new waveform (e.g., a new radio access technology (RAT)) to flexibly accommodate various services/applications with different requirements, new multiple access schemes to support massive connections, and so on.

### SUMMARY

The present disclosure relates to UE initiated transmissions in a wireless communication system.

In one embodiment, a user equipment (UE) is provided. The UE includes a transceiver configured to receive first information for resources related to a first transmission and receive second information for multiple resource configurations related to a second transmission. The UE further includes a processor operably coupled to the transceiver. The processor is configured to determine a first resource configuration from the multiple resource configurations. The transceiver is further configured to transmit the first transmission indicating the first resource configuration of the second transmission, transmit the second transmission, when the second transmission is successfully decoded at a base station (BS), receive a first signal that includes a first uplink (UL) grant for a third transmission, and transmit the third transmission based on the first UL grant.

In another embodiment, a BS is provided. The BS includes a transceiver configured to transmit first information for resources related to a first transmission, transmit second information for multiple resource configurations related to a second transmission, receive the first transmission indicating a first resource configuration of the second transmission, and receive the second transmission based on the first resource configuration. The BS further includes a processor operably coupled to the transceiver. The processor is configured to, when the second transmission is successfully decoded, determine a first UL grant related to a third transmission. The transceiver is further configured to transmit a first signal that includes the first UL grant and receive the third transmission based on the first UL grant.

In yet another embodiment, a method of operating a UE is provided. The method includes receiving first information for resources related to a first transmission, receiving second information for multiple resource configurations related to a second transmission, and determining a first resource configuration from the multiple resource configurations. The method further includes transmitting the first transmission indicating the first resource configuration of the second transmission, transmitting the second transmission, when the second transmission is successfully decoded at a BS, receiving a first signal that includes a first UL grant for a third transmission, and transmitting the third transmission based on the first UL grant.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be provided. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example of wireless network according to embodiments of the present disclosure;

FIG. 2 illustrates an example of gNB according to embodiments of the present disclosure;

FIG. 3 illustrates an example of UE according to embodiments of the present disclosure;

FIGS. 4 and 5 illustrate examples of wireless transmit and receive paths according to the present disclosure;

FIG. 6 illustrates an example of antenna structure according to embodiments of the present disclosure;

FIG. 7 illustrates an example of physical uplink control channel (PUCCH) format 0 according to embodiments of the present disclosure;

FIG. 8 illustrates an example of PUCCH format 1 according to embodiments of the present disclosure;

FIG. 9 illustrates an example of a PUCCH resource set according to embodiments of the present disclosure;

FIG. 10 illustrates an example of DL MAC PDU according to embodiments of the present disclosure;

FIG. 11 illustrates an example of UL MAC PDU according to embodiments of the present disclosure;

FIG. 12 illustrates a signaling flow of scheduling grant according to embodiments of the present disclosure;

FIG. 13 illustrates a signaling flow of wireless channel dynamically pre-allocating UL resources according to embodiments of the present disclosure;

FIG. 14 illustrates an example of resources in time and frequency domains according to embodiments of the present disclosure;

FIG. 15 illustrates an example of pre-notification channel or signal before a UE initiated UL transmission according to embodiments of the present disclosure;

FIG. 16 illustrates an example of resource configuration for UE-initiated transmissions according to embodiments of the present disclosure;

FIG. 17 illustrates an example of resource allocation according to embodiments of the present disclosure;

FIG. 18 illustrates an example of transmission occasion for configured grant-physical uplink shared channel (CG-PUSCH) according to embodiments of the present disclosure;

FIG. 19 illustrates an example of first physical channels in first UE resources according to embodiments of the present disclosure;

FIG. 20 illustrates an example of symbols carrying m-bits of information according to embodiments of the present disclosure;

FIG. 21 illustrates an example of UE initiated transmission with a first part and a second part according to embodiments of the present disclosure;

FIG. 22 illustrates an example of UE transmission resources used for pre-notification, UE initiated transmissions, scheduled transmissions according to embodiments of the present disclosure;

FIG. 23 illustrates another example of UE transmission resources used for UE initiated transmissions, scheduled transmissions according to embodiments of the present disclosure;

FIG. 24 illustrates a flowchart of method for retransmission of UE initiated transmission according to embodiments of the present disclosure;

FIG. 25 illustrates a flowchart of method for retransmission or new transmission in granted resources according to embodiments of the present disclosure;

FIG. 26 illustrates an example of UE transmission according to embodiments of the present disclosure;

FIG. 27 illustrates another example of UE transmission according to embodiments of the present disclosure;

FIG. 28 illustrates an example of UE transmission with 2 CG-PUSCH configurations according to embodiments of the present disclosure; and

FIG. 29 illustrates an example of various GC-DCI according to embodiments of the present disclosure.

### DETAILED DESCRIPTION

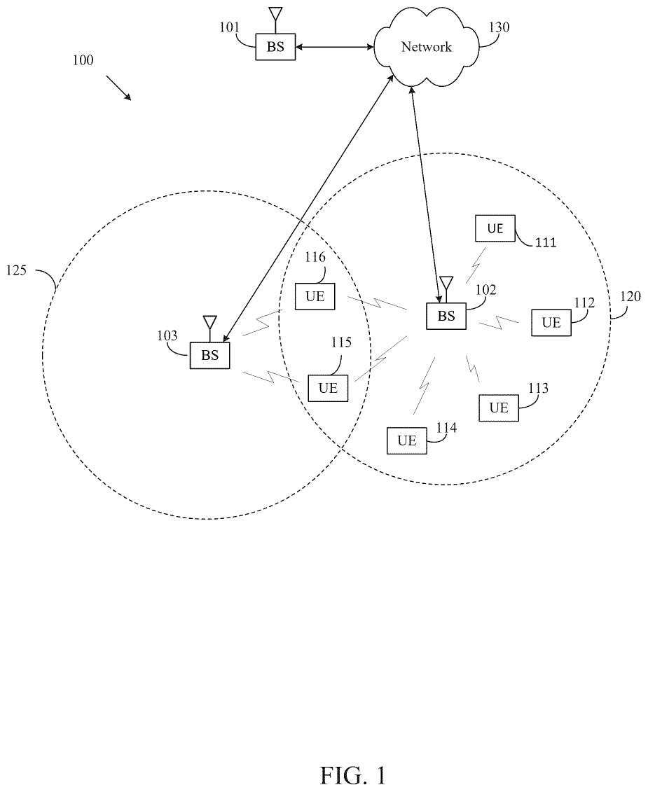

FIG. 1 through FIG. 29, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

The following documents are hereby incorporated by reference into the present disclosure as if fully set forth herein: 3GPP TS 38.211 v18.2.0, “NR; Physical channels and modulation” [REF1]; 3GPP TS 38.212 v18.2.0, “NR; Multiplexing and Channel coding” [REF2]; 3GPP TS 38.213 v18.2.0, “NR; Physical Layer Procedures for Control” [REF3]; 3GPP TS 38.214 v18.2.0, “NR; Physical Layer Procedures for Data” [REF4]; 3GPP TS 38.321 v18.1.0, “NR; Medium Access Control (MAC) protocol specification” [REF5]; and 3GPP TS 38.331 v18.1.0, “NR; Radio Resource Control (RRC) Protocol Specification” [REF6].

Wireless communication has been one of the most successful innovations in modern history. Recently, the number of subscribers to wireless communication services exceeded five billion and continues to grow quickly. The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage is of paramount importance.

To meet the demand for wireless data traffic having increased since deployment of 4G communication systems, and to enable various vertical applications, 5G communication systems have been developed and are being deployed.

The 5G communication system is provided to be implemented to include higher frequency (mmWave) bands, such as 28 GHz or 60 GHz bands or, in general, above 6 GHz bands, so as to accomplish higher data rates, or in lower frequency bands, such as below 6 GHz, to enable robust coverage and mobility support. Aspects of the present disclosure may be applied to deployment of 5G communication systems, 6G or even later releases which may use THz bands. To decrease propagation loss of the radio waves and increase the transmission distance, the beamforming, massive multiple-input multiple-output (MIMO), Full Dimensional MIMO (FD-MIMO), array antenna, an analog beam forming, large-scale antenna techniques are discussed in 5G communication systems.

In addition, in 5G communication systems, development for system network improvement is under way based on advanced small cells, cloud radio access networks (RANs), ultra-dense networks, device-to-device (D2D) communication, wireless backhaul, moving network, cooperative communication, coordinated multi-points (COMP), reception-end interference cancellation and the like.

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to the manner in which different embodiments may be implemented. Different embodiments of the present disclosure may be implemented in any suitably arranged communications system.

FIG. 1 illustrates an example of a wireless network according to embodiments of the present disclosure. The embodiment of the wireless network shown in FIG. 1 is for illustration only. Other embodiments of the wireless network 100 could be used without departing from the scope of the present disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3rd generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof, for performing UE initiated transmissions in a wireless communication system. In certain embodiments, and one or more of the gNBs 101-103 includes circuitry, programing, or a combination thereof, for supporting a UE initiated transmission in a wireless communication system.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

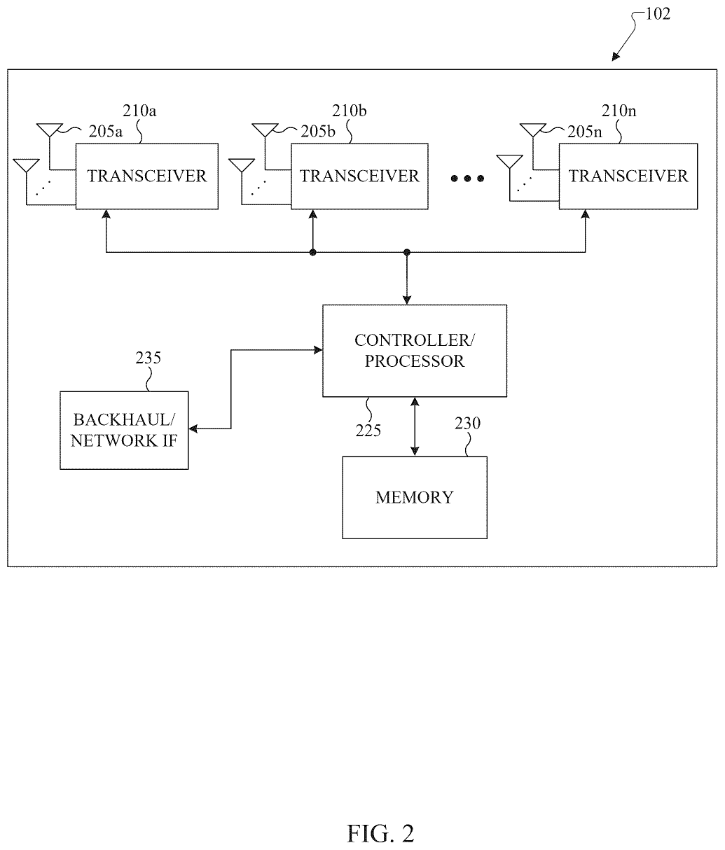

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of the present disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming RF signals, such as signals transmitted by UEs in the network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of UL channels or signals and the transmission of DL channels or signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. Any of a wide variety of other functions could be supported in the gNB 102 by the controller/processor 225.

The controller/processor 225 is also capable of executing programs and other processes resident in the memory 230, such as processes for supporting UE initiated transmissions in a wireless communication system. The controller/processor 225 can move data into or out of the memory 230 as executed by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

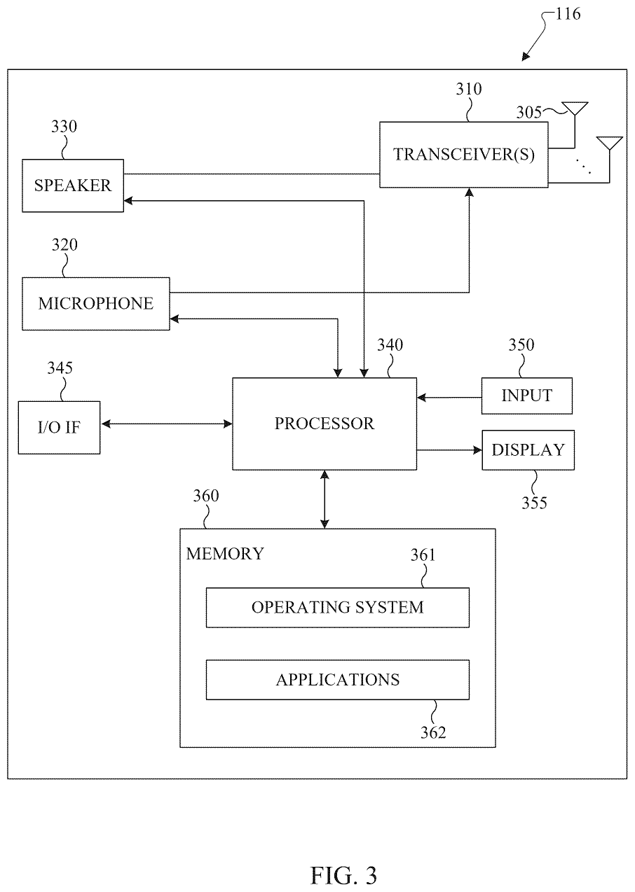

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of the present disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna 305, an incoming RF signal transmitted by a gNB of the network 100 or by other UEs (e.g., one or more of UEs 111-115) on a sidelink (SL) channel. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channels or signals, the transmission of UL channels or signals, and reception and transmission of SL channels or signals by the transceiver(s) 310 in accordance with well-known principles. In some embodiments, the processor 340 includes at least one microprocessor or microcontroller. The processor 340 is also capable of executing other processes and programs resident in the memory 360, such as processes for a UE initiated transmission in a wireless communication system.

The processor 340 can move data into or out of the memory 360 as provided by an executing process. In some embodiments, the processor 340 is configured to execute the applications 362 based on the OS 361 or in response to signals received from gNBs, another UE, or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350 and the display 355 which includes for example, a touchscreen, keypad, etc., The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

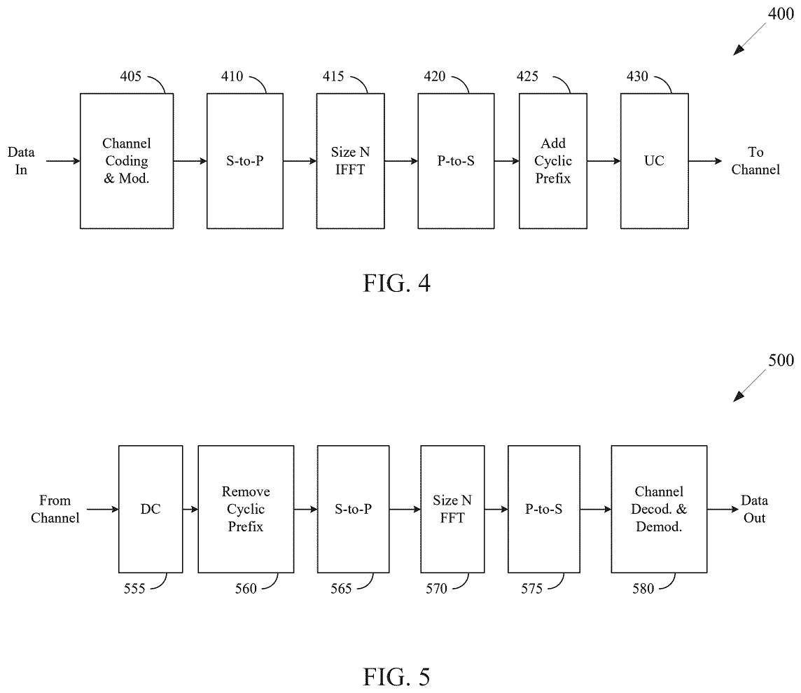

FIG. 4 and FIG. 5 illustrate example wireless transmit and receive paths according to the present disclosure. The transmit path 400 as illustrated in FIG. 4 includes a channel coding and modulation block 405, a serial-to-parallel (S-to-P) block 410, a size N inverse fast Fourier transform (IFFT) block 415, a parallel-to-serial (P-to-S) block 420, an add cyclic prefix block 425, and an up-converter (UC) 430. The receive path 500 as illustrated in FIG. 5 includes a down-converter (DC) 555, a remove cyclic prefix block 560, a serial-to-parallel (S-to-P) block 565, a size N fast Fourier transform (FFT) block 570, a parallel-to-serial (P-to-S) block 575, and a channel decoding and demodulation block 580.

As illustrated in FIG. 4, the channel coding and modulation block 405 receives a set of information bits, applies coding (such as a low-density parity check (LDPC) coding), and modulates the input bits (such as with quadrature phase shift keying (QPSK) or quadrature amplitude modulation (QAM)) to generate a sequence of frequency-domain modulation symbols.

The serial-to-parallel block 410 converts (such as de-multiplexes) the serial modulated symbols to parallel data in order to generate N parallel symbol streams, where N is the IFFT/FFT size used in the gNB 102 and the UE 116. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to an RF frequency for transmission via a wireless channel. The signal may also be filtered at baseband before conversion to the RF frequency.

A transmitted RF signal from the gNB 102 or another UE arrives at the UE 116 after passing through the wireless channel, and reverse operations to those at the gNB 102 or another UE are performed at the UE 116.

As illustrated in FIG. 5, the down converter 555 down-converts the received signal to a baseband frequency, and the remove cyclic prefix block 560 removes the cyclic prefix to generate a serial time-domain baseband signal. The serial-to-parallel block 565 converts the time-domain baseband signal to parallel time domain signals. The size N FFT block 570 performs an FFT algorithm to generate N parallel frequency-domain signals. The parallel-to-serial block 575 converts the parallel frequency-domain signals to a sequence of modulated data symbols. The channel decoding and demodulation block 580 demodulates and decodes the modulated symbols to recover the original input data stream.

Each of the gNBs 101-103 may implement a transmit path 400 as illustrated in FIG. 4 that is analogous to transmitting in the downlink to UEs 111-116 and may implement a receive path 500 as illustrated in FIG. 5 that is analogous to receiving in the uplink from UEs 111-116. Similarly, each of UEs 111-116 may implement the transmit path 400 for transmitting in the uplink to the gNBs 101-103 or transmitting in the sidelink to another UE and may implement the receive path 500 for receiving in the downlink from the gNBs 101-103 or receiving in the sidelink from another UE. In some embodiments, the transmit path 400 and/or receive path 500 is configured to support a UE initiated transmission in a wireless communication system as described in embodiments of the present disclosure.

Each of the components in FIG. 4 and FIG. 5 can be implemented using only hardware or using a combination of hardware and software/firmware. As a particular example, at least some of the components in FIG. 4 and FIG. 5 may be implemented in software, while other components may be implemented by configurable hardware or a mixture of software and configurable hardware. For instance, the FFT block 570 and the IFFT block 415 may be implemented as configurable software algorithms, where the value of size N may be modified according to the implementation.

Furthermore, although described as using FFT and IFFT, this is by way of illustration only and may not be construed to limit the scope of the present disclosure. Other types of transforms, such as discrete Fourier transform (DFT) and inverse discrete Fourier transform (IDFT) functions, can be used. It may be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIG. 4 and FIG. 5 illustrate examples of wireless transmit and receive paths, various changes may be made to FIG. 4 and FIG. 5. For example, various components in FIG. 4 and FIG. 5 can be combined, further subdivided, or omitted and additional components can be added according to particular needs. Also, FIG. 4 and FIG. 5 are meant to illustrate examples of the types of transmit and receive paths that can be used in a wireless network. Any other suitable architecture can be used to support wireless communications in a wireless network.

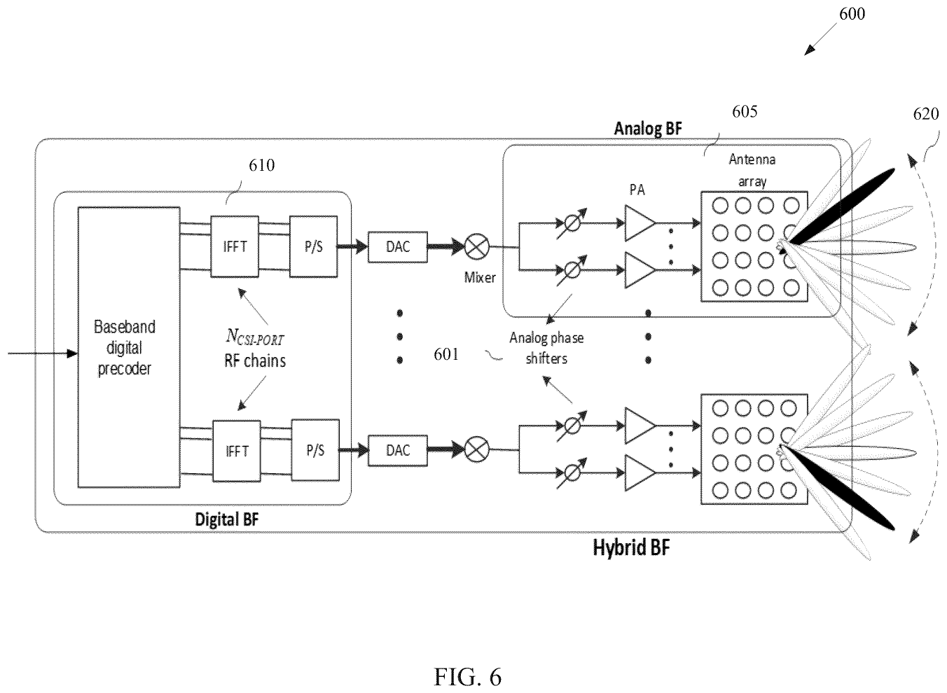

FIG. 6 illustrates an example of antenna structure 600 according to embodiments of the present disclosure. An embodiment of the antenna structure 600 shown in FIG. 6 is for illustration only.

In this case, one CSI-RS port is mapped onto a large number of antenna elements which can be controlled by a bank of analog phase shifters 601. One CSI-RS port can then correspond to one sub-array which produces a narrow analog beam through analog beamforming 605. This analog beam can be configured to sweep across a wider range of angles 620 by varying the phase shifter bank across symbols or subframes. The number of sub-arrays (equal to the number of RF chains) is the same as the number of CSI-RS ports NCSI-PORT. A digital beamforming unit 610 performs a linear combination across NCSI-PORT analog beams to further increase precoding gain. While analog beams are wideband (hence not frequency-selective), digital precoding can be varied across frequency sub-bands or resource blocks. Receiver operation can be conceived analogously.

Since the mentioned system utilizes multiple analog beams for transmission and reception (wherein one or a small number of analog beams are selected out of a large number, for instance, after a training duration—to be performed from time to time), the term “multi-beam operation” is used to refer to the overall system aspect. This includes, for the purpose of illustration, indicating the assigned DL or UL or SL TX beam (also termed “beam indication”), measuring at least one reference signal for calculating and performing beam reporting (also termed “beam measurement” and “beam reporting,” respectively), and receiving a DL or UL or SL transmission via a selection of a corresponding RX beam.

The system is also applicable to higher frequency bands such as >52.6 GHz. In this case, the system can employ only analog beams. Due to the O2 absorption loss around 60 GHz frequency (˜10 dB additional loss @100m distance), larger number of and sharper analog beams (hence larger number of radiators in the array) may be used to compensate for the additional path loss.

Rel.14 LTE and Rel.15 NR support up to 32 CSI-RS antenna ports which enable an eNB to be equipped with a large number of antenna elements (such as 64 or 128). In this case, a plurality of antenna elements is mapped onto one CSI-RS port. For mmWave bands, although the number of antenna elements can be larger for a given form factor, the number of CSI-RS ports-which can correspond to the number of digitally precoded ports-tends to be limited due to hardware constraints (such as the feasibility to install a large number of ADCs/DACs at mmWave frequencies) as illustrated in FIG. 6.

A unit for DL signaling, for UL signaling or for SL signaling on a cell is referred to as a slot and can include one or more symbols. A bandwidth (BW) unit is referred to as a resource block (RB). One RB includes a number of sub-carriers (SCs). For example, a slot can have duration of one millisecond and an RB can have a bandwidth of 180 KHz and include 12 SCs with inter-SC spacing of 15 KHz. A slot can be either full DL slot, a full UL slot, or a hybrid slot similar to a special subframe in time division duplex (TDD) systems (see also REF 1). In addition, a slot can have symbols for SL communications.

DL signals include data signals conveying information content, control signals conveying DL control information (DCI), and reference signals (RS) that are also known as pilot signals. A gNB transmits data information or DCI through respective physical DL shared channels (PDSCHs) or physical DL control channels (PDCCHs). A PDSCH or a PDCCH can be transmitted over a variable number of slot symbols including one slot symbol. A UE can be indicated a spatial setting for a PDCCH reception based on a configuration of a value for a transmission configuration indication state (TCI state) of a control resource set (CORESET) where the UE receives the PDCCH. The UE can be indicated a spatial setting for a PDSCH reception based on a configuration by higher layers or based on an indication by a DCI format scheduling the PDSCH reception of a value for a TCI state. The gNB can configure the UE to receive signals on a cell within a DL bandwidth part (BWP) of the cell DL BW.

A gNB transmits one or more of multiple types of RS including channel state information RS (CSI-RS) and demodulation RS (DMRS)—see also REF 1. A CSI-RS is primarily intended for UEs to perform measurements and provide channel state information (CSI) to a gNB. For channel measurement, non-zero power CSI-RS (NZP CSI-RS) resources are used. For interference measurement reports (IMRs), CSI interference measurement (CSI-IM) resources associated with a zero power CSI-RS (ZP CSI-RS) configuration are used (see also REF 3). A CSI process comprises NZP CSI-RS and CSI-IM resources. A UE can determine CSI-RS transmission parameters through DL control signaling or higher layer signaling, such as radio resource control (RRC) signaling from a gNB (see also REF 5). Transmission instances of a CSI-RS can be indicated by DL control signaling or configured by higher layer signaling. A DMRS is transmitted only in the BW of a respective PDCCH or PDSCH and a UE can use the DMRS to demodulate data or control information.

UL signals also include data signals conveying information content, control signals conveying UL control information (UCI), DMRS associated with data or UCI demodulation, sounding RS (SRS) enabling a gNB to perform UL channel measurement, and a random access (RA) preamble enabling a UE to perform random access (see also REF 1). A UE transmits data information or UCI through a respective physical UL shared channel (PUSCH) or a physical UL control channel (PUCCH). A PUSCH or a PUCCH can be transmitted over a variable number of slot symbols including one slot symbol. The gNB can configure the UE to transmit signals on a cell within an UL BWP of the cell UL BW.

UCI includes hybrid automatic repeat request acknowledgement (HARQ-ACK) information, indicating correct or incorrect detection of data transport blocks (TBs) in a PDSCH, scheduling request (SR) indicating whether a UE has data in its buffer, a link recovery request (LRR) for beam failure recovery, and CSI reports enabling a gNB to select appropriate parameters for PDSCH or PDCCH transmissions to a UE. A CSI report can comprise a single part, or for two parts (e.g., part 1 CSI and part 2 CSI). HARQ-ACK information can be configured with a smaller granularity than per TB and can be per data code block (CB) or per group of data CBs where a data TB includes a number of data CBs.

A CSI report from a UE can include a channel quality indicator (CQI) informing a gNB of a largest modulation and coding scheme (MCS) for the UE to detect a data TB with a predetermined block error rate (BLER), such as a 10% BLER (see also REF 3), of a precoding matrix indicator (PMI) informing a gNB how to combine signals from multiple transmitter antennas in accordance with a multiple input multiple output (MIMO) transmission principle, and of a rank indicator (RI) indicating a transmission rank for a PDSCH. UL RS includes DMRS and SRS. DMRS is transmitted only in a BW of a respective PUSCH or PUCCH transmission. A gNB can use a DMRS to demodulate information in a respective PUSCH or PUCCH. SRS is transmitted by a UE to provide a gNB with an UL CSI and, for a TDD system, an SRS transmission can also provide a PMI for DL transmission. Additionally, in order to establish synchronization or an initial higher layer connection with a gNB, a UE can transmit a physical random access channel (PRACH, see also REF 3 and REF 4).

The UL control information (UCI) can be multiplexed on physical uplink control channel (PUCCH). There are 5 PUCCH formats, depending on the length of the PUCCH format (number of symbols of the PUCCH format), and the UCI payload size as illustrated in TABLE 1.

TABLE 1
UCI payload

| | UCI payload | UCI payload more |
|---|---|---|
| | 1 or 2 bit | than 2 bits |
| PUCCH length | PUCCH format 0 | PUCCH format 2 |
| 1 or 2 symbols | | |
| PUCCH length | PUCCH format 1 | PUCCH format 3 or 4 |
| 4 to 14 symbols | | |

A PUCCH format 0 is allocated 1 RB with 1 or 2 symbols. Each RB can multiplex 12 cyclic shifts. When HARQ-ACK feedback on PUCCH format 0 has 1-bit, two cyclic shifts are used, one for ACK, and the other for NACK. When HARQ-ACK feedback on PUCCH format 0 has 2-bits, four shifts are used for the following pairs (ACK, ACK), (ACK, NACK), (NACK, ACK) and (NACK, NACK).

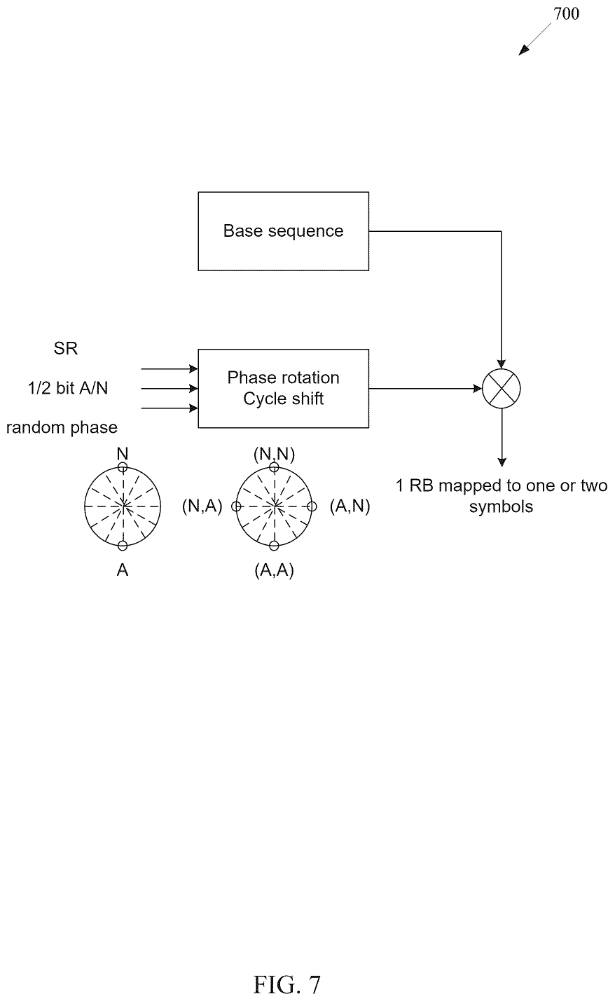

FIG. 7 illustrates an example of PUCCH format 0 700 according to embodiments of the present disclosure. An embodiment of the PUCCH format 0 700 shown in FIG. 7 is for illustration only.

The PUCCH format 1 is allocated 1 RB with 4 to 14 symbols. The symbols are split between DMRS symbols, and data symbols. DMRS are reference symbols used for coherent demodulation. Frequency hopping can be used where approximately half the symbols use one frequency hop, and the other half uses another frequency hop. The HARQ-ACK feedback is modulated using BPSK for 1-bit HARQ-ACK and using QPSK for 2-bit HARQ-ACK.

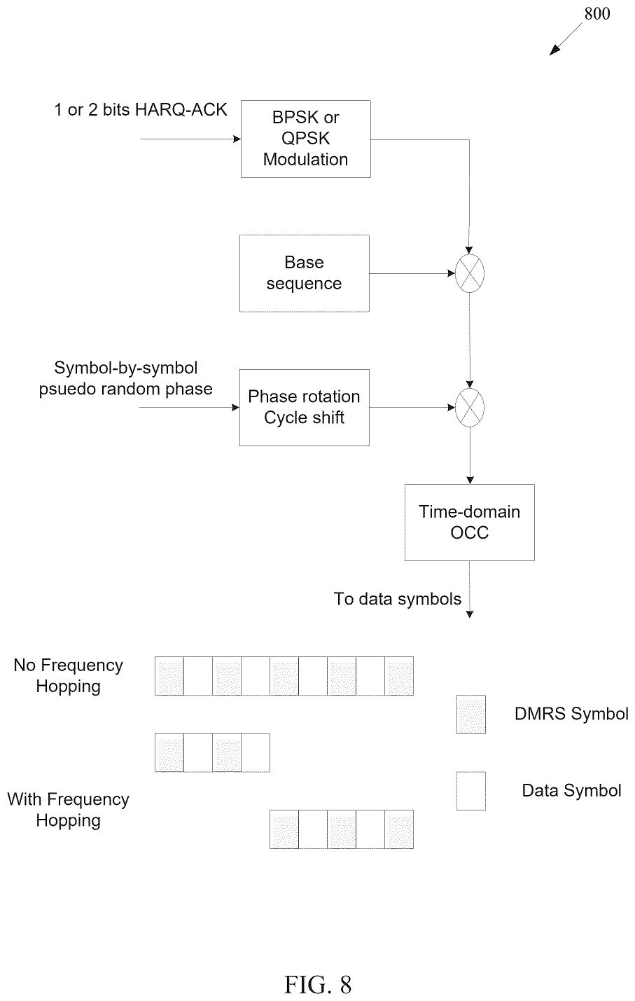

FIG. 8 illustrates an example of PUCCH format 1 800 according to embodiments of the present disclosure. An embodiment of the PUCCH format 1 800 shown in FIG. 8 is for illustration only.

FIG. 8 illustrates an example of PUCCH format 1, with 9 symbols with and without frequency hopping.

The PUCCH format 4 has 1 RB and can multiplex 2 or 4 users on the same physical resource using different spreading codes in frequency domain.

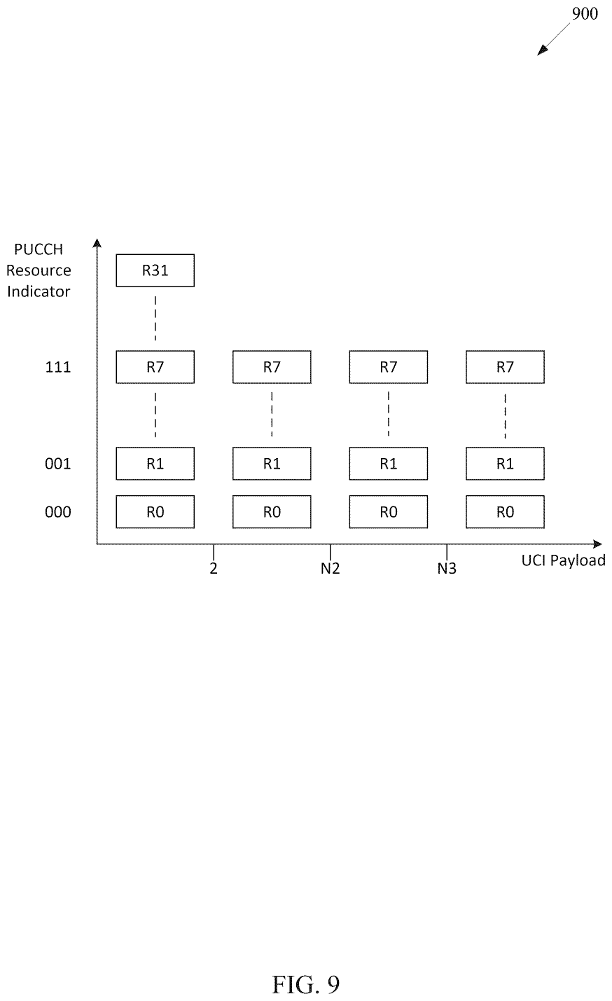

The network can configure 4 PUCCH resource sets, where each PUCCH resource set is associated with a UCI payload size. The first PUCCH resource set is used for payload size≤2 bits and can have up to 32 PUCCH resources. The second PUCCH resource set is used for 2<payload size≤N₂. The third PUCCH resource set is used for N₂<payload size≤N₃. The fourth PUCCH resource set is used for payload size >N₃. Each of the second, third and fourth PUCCH resource sets can have 8 PUCCH resources. This is illustrated in FIG. 9.

FIG. 9 illustrates an example of PUCCH resource set 900 according to embodiments of the present disclosure. An embodiment of the PUCCH resource set 900 shown in FIG. 9 is for illustration only.

A PUCCH resource is determined by PUCCH resource index (PRI), channel control element (CCE) index (when payload size is 1 or 2 bits) and payload size.

When the CSI report is a single part, the UE multiplexes the HARQ-ACK information, the scheduling request, and the CSI information into a single UCI message. This message is then encoded, rate-matched, scrambled, modulated and mapped to the resource elements of PUCCH not used for DMRS. When the CSI report has two parts, a first part CSI and a second part CSI. The first part UCI information comprises HARQ-ACK information, scheduling request and first part CSI. The second part UCI information comprises the second part CSI.

The mapping of UCI information to PUCCH resource element is performed as follows: (i) first, the first part UCI information is mapped to PUCCH OFDM symbols that are closest to DMRS symbols; and (ii) next, the second part UCI information is mapped to the remaining PUCCH resource elements.

When a PUCCH transmission overlaps with a PUSCH transmission, the UCI information is multiplexed onto the PUSCH channel: (i) first, HARQ-ACK information is multiplexed into PUSCH starting from the first OFDM symbol after the first DMRS symbol in each frequency hop, (ii) next, the first part CSI is multiplexed into PUSCH starting from the first OFDM symbol of each frequency hop, (iii) subsequently, the second part CSI is multiplexed into PUSCH after the first part CSI, and (iv) finally, the transport block from higher layers is multiplexed into the remaining PUSCH resource elements not used for other purposes.

A transport block, from higher layers, are provided for MAC PDU, which can comprise one or more of: (i) fixed-size MAC CE(s), (ii) variable size MAC CE(s), (iii) MAC SDU(s), and (iv) optional padding.

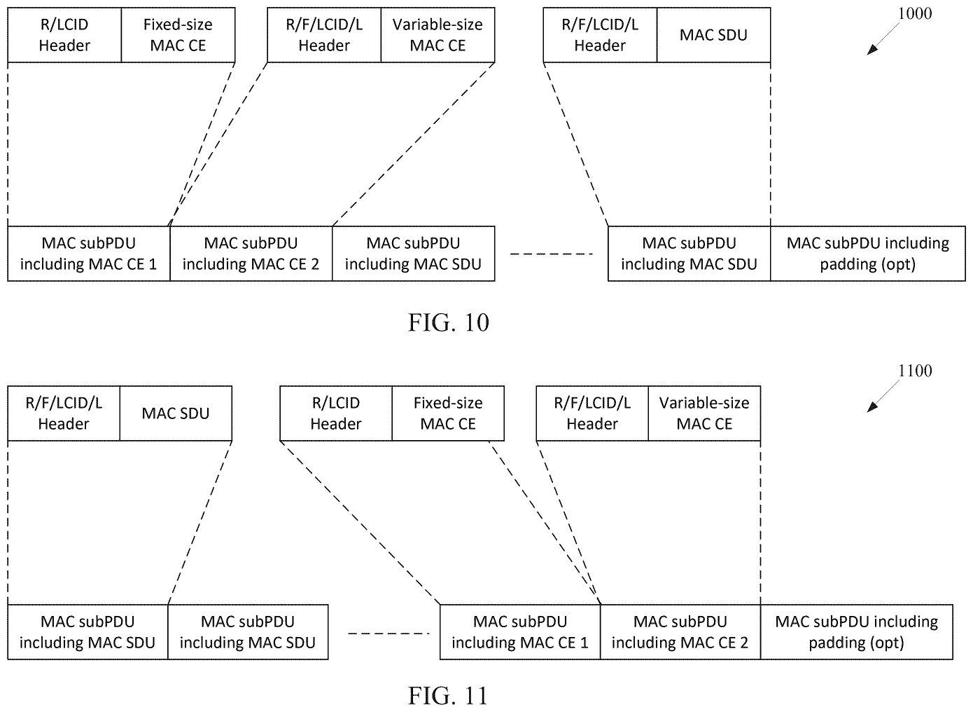

FIG. 10 illustrates an example of DL MAC PDU 1000 according to embodiments of the present disclosure. An embodiment of the DL MAC PDU 1000 shown in FIG. 10 is for illustration only.

FIG. 11 illustrates an example of UL MAC PDU 1100 according to embodiments of the present disclosure. An embodiment of the UL MAC PDU 1100 shown in FIG. 11 is for illustration only.

A DL MAC PDU (e.g., transport block) is illustrated in FIG. 10. An UL MAC PDU (e.g., transport block) L is illustrated in FIG. 11.

SL signals and channels are transmitted and received on sub-channels within a resource pool, where a resource pool is a set of time-frequency resources used for SL transmission and reception within a SL BWP. SL channels include physical SL shared channels (PSSCHs) conveying data information, physical SL control channels (PSCCHs) conveying SL control information (SCI) for scheduling transmissions/receptions of PSSCHs, physical SL feedback channels (PSFCHs) conveying hybrid automatic repeat request acknowledgement (HARQ-ACK) information in response to correct (ACK value) or incorrect (NACK value) transport block receptions in respective PSSCHs; PSFCHs can also carry conflict indications, and physical SL Broadcast channel (PSBCH) conveying system information to assist in SL synchronization.

SL signals include demodulation reference signals DM-RS that are multiplexed in PSSCH or PSCCH transmissions to assist with data or SCI demodulation, channel state information reference signals (CSI-RS) for channel measurements, phase tracking reference signals (PT-RS) for tracking a carrier phase, and SL primary synchronization signals (S-PSS) and SL secondary synchronization signals (S-SSS) for SL synchronization. The SCI can be split into two parts/stages corresponding to two respective SCI formats; the first SCI format is multiplexed on a PSCCH, while the second SCI format is multiplexed along with SL data on a PSSCH that is transmitted in physical resources indicated by the first SCI format.

In the present disclosure, a beam can be determined by one of: (i) a TCI state, that establishes a quasi-colocation (QCL) relationship or spatial relation between a source reference signal (e.g., synchronization signal/Physical broadcast channel (SS/PBCH) block (SSB) and/or CSI-RS) and a target reference signal or (ii) a spatial relation information that establishes an association to a source reference signal, such as SSB or CSI-RS or SRS. In either case, the ID of the source reference signal identifies the beam.

The TCI state and/or the spatial relation reference RS can determine a spatial Rx filter or quasi-co-location (QCL) properties for a reception of downlink channels at the UE, or a spatial Tx filter for a transmission of uplink channels from the UE. The TCI state and/or the spatial relation reference RS can determine a spatial Tx filter for transmission of downlink channels from the gNB, or a spatial Rx filter or QCL properties for reception of uplink channels at the gNB.

Rel-17 introduced the unified TCI framework, where a unified, master, main, or indicated TCI state is signaled to the UE. The unified, master, main, or indicated TCI state can be one of: (i) in case of joint TCI state indication, wherein a same beam is used for DL and UL channels, a joint TCI state that can be used at least for UE-dedicated DL channels and UE-dedicated UL channels, (ii) in case of separate TCI state indication, wherein different beams are used for DL and UL channels, a DL TCI state that can be used at least for UE-dedicated DL channels, or (iii) in case of separate TCI state indication, wherein different beams are used for DL and UL channels, a UL TCI state that can be used at least for UE-dedicated UL channels.

The unified (master, main, or indicated) TCI state is TCI state of UE-dedicated reception on PDSCH/PDCCH or dynamic-grant/configured-grant based PUSCH and all of dedicated PUCCH resources.

The unified TCI framework applies to intra-cell beam management, wherein, the TCI states have a source RS that is directly or indirectly associated, through a quasi-co-location relation, e.g., spatial relation, with an SSB of a serving cell (e.g., the TCI state is associated with a TRP of a serving cell). The unified TCI state framework also applies to inter-cell beam management, wherein a TCI state can have a source RS that is directly or indirectly associated, through a quasi-co-location relation, e.g., spatial relation, with an SSB of cell that has a physical cell identity (PCI) different from the PCI of the serving cell (e.g., the TCI state is associated with a TRP of a cell having a PCI different from the PCI of the serving cell).

QCL relation can be quasi-location with respect to one or more of the following relations: (i) Type A, {Doppler shift, Doppler spread, average delay, delay spread}; (ii) Type B, {Doppler shift, Doppler spread}; (iii) Type C, {Doppler shift, average delay}, or (iv) Type D, {Spatial Rx parameter}.

In addition, quasi-co-location relation and source reference signal can also provide a spatial relation for UL channels, e.g., a DL source reference signal provides information on the spatial domain filter to be used for UL transmissions, or the UL source reference signal provides the spatial domain filter to be used for UL transmissions, e.g., same spatial domain filter for UL source reference signal and UL transmissions.

The unified (master, main, or indicated) TCI state applies at least to UE dedicated DL and UL channels. The unified (master, main, or indicated) TCI can also apply to other DL and/or UL channels and/or signals e.g., non-UE dedicated channel and SRS.

A UE is indicated with a TCI state by MAC CE when the MAC CE activates one TCI state code point. The UE applies the TCI state code point after a beam application time from the corresponding HARQ-ACK feedback. A UE is indicated with a TCI state by a DL related DCI format (e.g., DCI format 1_1, or DCI format 1_2), wherein the DCI format includes a “transmission configuration indication” field that includes a TCI state code point out of the TCI state code points activated by a MAC CE. A DL related DCI format can be used to indicate a TCI state when the UE is activated with more than one TCI state code points. The DL related DCI format can be with a DL assignment for a PDSCH reception or without a DL assignment. A TCI state (TCI state code point) indicated in a DL related DCI format is applied after a beam application time from the corresponding HARQ-ACK feedback.

In the present disclosure, embodiments related to UE-initiated transmissions are provided, where a UE has data to transmit. In one example, the UE proceeds with the UE-initiated transmission, before the transmission, the UE can send a pre-notification signal or a UE initiated (UEI) indicator. In another example, the UE can notify the network about the amount (size) of resources to select or the selected resources, and the network either confirms or not confirms the request, and based on that the UE proceeds or not with the transmission.

A wireless channel is a shared channel that can be used by more than one user. To avoid collisions between users a resource allocation schemes are used. Resource allocation schemes can be dynamic or semi-static. Resource allocation schemes have different requirements and constraints such as dealing with traffic having different transmission characteristics (e.g., periodic vs sporadic, transport block size, etc.) and having different quality-of-service (QOS) profiles (e.g., latency, priority, etc.) for different users. At the same time, resource allocation schemes are excepted to efficiently utilized the bandwidth of the wireless channel. Some of these requirements and constraints can be seemingly contradictory.

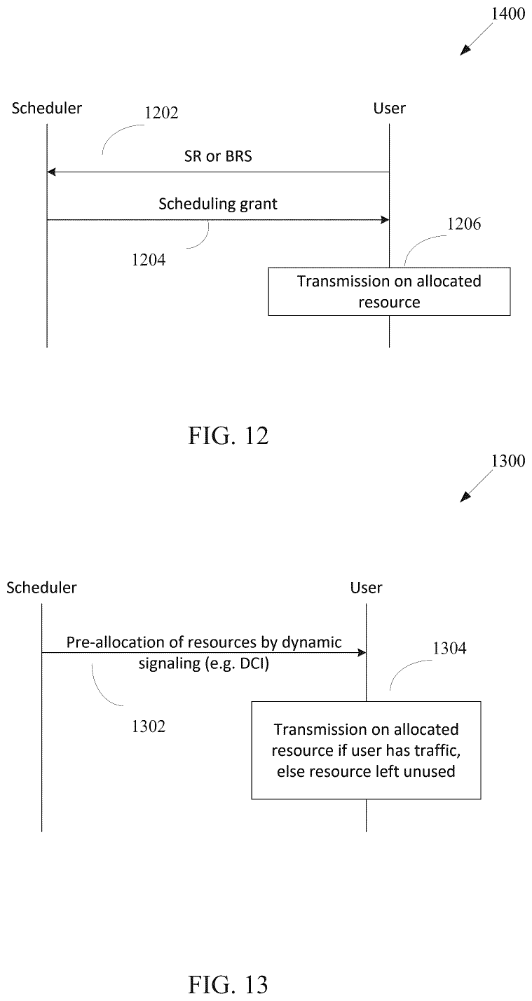

For example, in case of dynamic resource allocation, a user can send a scheduling request (SR) or buffer status report (BSR) to a scheduler, when the user requests resources to transmit over the wireless channel, the scheduler allocates resources to the user and sends a scheduling grant indicating the allocated resources to the user, the user then uses the scheduling grant to transmit over the wireless channel as illustrated in FIG. 12. However, this procedure, of sending a SR/BSR and waiting for a scheduling grant before transmitting increases latency and may not meet latency requirements for ultra-reliable low latency communications (URLLC) or hyper-reliable low latency communications (HRLLC).

FIG. 12 illustrates a signaling flow of scheduling grant 1200 according to embodiments of the present disclosure. The scheduling grant 1200 as may be performed by a UE (e.g., 111-116 as illustrated in FIG. 1) and a base station (e.g., 101-103). The UE may be implemented as a user and the base station may be implemented as a scheduler. An embodiment of the scheduling grant 1200 shown in FIG. 12 is for illustration only. One or more of the components illustrated in FIG. 12 can be implemented in a specialized circuitry configured to perform the noted functions or one or more of the components can be implemented by one or more processors executing instructions to perform the noted functions.

As illustrated in FIG. 12, in step 1202, a user transmits an SR or BRS to a scheduler. In step 1204, the scheduler transmits a scheduling grant. The user, after receiving the scheduling grant, performs a transmission on allocated resource. In step 1206, the user performs a transmission on allocated resources, and base station correspondingly receives the transmission.

Alternatively, the scheduler can pre-allocate resources to the user by allocating resources to the user before the scheduler is aware that the user has traffic to transmit. If the user has traffic to transmit, the user uses the allocated resource (hence reducing latency), however, if the user has no traffic to transmit the resource is left unused, hence wasting wireless channel resources and leading to lower wireless channel resource utilization efficiency. This is illustrated in FIG. 13.

FIG. 13 illustrates a signaling flow of wireless channel dynamically pre-allocating UL resources 1300 according to embodiments of the present disclosure. The signaling flow of wireless channel dynamically pre-allocating UL resources 1300 as may be performed by a UE (e.g., 111-116 as illustrated in FIG. 1) and a base station (e.g., 101-103). The UE may be implemented as a user and the base station may be implemented as a scheduler. An embodiment of the signaling flow of wireless channel resource utilization efficiency 1300 shown in FIG. 13 is for illustration only. One or more of the components illustrated in FIG. 13 can be implemented in a specialized circuitry configured to perform the noted functions or one or more of the components can be implemented by one or more processors executing instructions to perform the noted functions.

As illustrated in FIG. 13, in step 1302, a scheduler transmits pre-allocation of resources by dynamic signals and a user in step 1304 performs a transmission on allocated resource if a user has traffic, and base station correspondingly receives the transmission. If there is no transmission, the user leaves the resources unused.

To address this issue, the scheduler can pre-allocate resources to multiple users, a user that has traffic to send can use the resource. However, users are unaware of the traffic status or transmission status of other users allocated the same resource. In fact, the users may not be even aware that other users have been allocated the same resource. This can lead to collision between users' transmissions. To mitigate this issue, the following embodiments are provided in the disclosure.

In one embodiment, a pre-notification message is sent before the UE-initiated transmission. There are two potential advantages of sending a pre-notification signal/message (UEI indicator) before the UE-initiated transmission. First, it reduces the decoding complexing of the receiving device as the pre-notification signal/message has lower decoding complexing than the actual UE-initiated transmission. The receiving device attempts to decode the UE-initiated transmission, when its presence is indicated by the pre-notification signal/message. Second, if the UE-initiated transmission of multiple UEs collide and are not successfully decoded, the pre-notification signal/message can indicate to the receiving device that a UE-initiated transmission was attempted but not successfully received allowing for some recovery procedure such as sending an indication to the UE for re-transmission and/or granting resources for re-transmission.

The present disclosure relates to an NR/5G and/or 6G communication system.

This disclosure provides aspects related to user initiated transmissions: (i) pre-notification message (UEI indicator) indicating resources for UE-initiated transmission; (ii) transmission parameters for UE-initiated transmission indicated in pre-notification message or a first part of a UE-initiated transmission; (iii) feedback to UE in response to UE-initiated for re-transmission. This can include group common (GC)-DCI signaling; (iv) scheduling request indicating resources for UE transmission; and (v) scheduling grant for UE to proceed or not with transmission on indicated resources.

In the present disclosure, both frequency division duplex (FDD) and time division duplex (TDD) are considered as a duplex method for DL and UL signaling. In addition, full duplex (XDD) operation is possible, e.g., sub-band full duplex (SBFD) or single frequency full duplex (SFFD). Although exemplary descriptions and embodiments to follow assume OFDM or OFDMA, the present disclosure can be extended to other OFDM-based transmission waveforms or multiple access schemes such as filtered OFDM (F-OFDM).

This disclosure provides several components that can be used in conjunction or in combination with one another, or can operate as standalone schemes.

In the present disclosure, an RRC signaling (e.g., configuration by RRC signaling) includes (1) common information provided by common signaling, e.g., this can be system information block (SIB)-based RRC signaling (e.g., SIB1 or other SIB) or (2) RRC dedicated signaling that is sent to a specific UE wherein the information can be common/cell-specific information or dedicated/UE-specific information or (3) UE-group RRC signaling.

In the present disclosure, a MAC CE signaling can be UE-specific e.g., to one UE or can be UE common (e.g., to a group of UEs or all UEs of a cell). MAC CE signaling can be DL MAC CE signaling or UL MAC CE signaling.

In the present disclosure, an L1 control signaling includes: (1) DL control information (e.g., DCI on PDCCH or DL control information on PDSCH) and/or (2) UL control information (e.g., UCI on PUCCH or PUSCH). An L1 control signaling is UE-specific e.g., to one UE or can be UE common (e.g., to a group of UEs or to all UEs of a cell) and/or (3) SL control information such PSFCH or the first stage SCI on PSCCH or the second stage SCI on PSSCH.

In this disclosure, configuration can refer to configuration by semi-static signaling (e.g., RRC or SIB signaling). In one example, a configuration can be applicable to multiple transmission instances, until a new configuration is received and applied.

In this disclosure, indication can refer to indication by dynamic signaling (e.g., L1 control (e.g., DCI Format) or MAC CE signaling). In one example, an indication can be for an associated occasion(s) (e.g., an occasion or multiple occasions associated with the indication).

In the present disclosure, a list with N elements can be denoted as L(i), where i can take N values, and L(i) can correspond to the element or entry associated with index i. In one example, i can take N arbitrary values. In one example, i=0, 1, . . . , N−1. In one example, i=1, 2, . . . , N. In one example, i is an identity of an element or entry in the list.

In the present disclosure, the term “activation” describes an operation wherein a UE receives and decodes first information provided by a first signal from the network (or gNB) and, based on the first information, the UE determines a starting point in time. The starting point can be a present or a future slot/subframe or symbol and the exact location is either implicitly or explicitly indicated, or is otherwise defined in the system operation or is configured by higher layers. Upon successfully decoding the first information, the UE responds according to an indication provided by the first information. The term “deactivation” describes an operation wherein a UE receives and decodes second information provided by a second signal from the network (or gNB) and, based on the second information from the signal, the UE determines a stopping point in time. The stopping point can be a present or a future slot/subframe or symbol and the exact location is either implicitly or explicitly indicated, or is otherwise defined in the system operation or is configured by higher layers. Upon successfully decoding the second information, the UE responds according to an indication provided by the second information. The first signal can be same as the second signal or the first information can be same as the second information, wherein a first part of the information can be associated with an “activation” operation and with first UEs or with first parameters for transmissions/receptions by a UE, and a second part of the information can be associated with a “deactivation” operation and with second UEs or with second parameters for transmissions/receptions by the UE. For example, the second information can be absent, and deactivation can be implicitly derived. For example, when a UE has received an activation information in a previous indication, and is not included among UEs with activation information in a next indication, the UE can determine the latter indication as an implicit deactivation indication.

In this disclosure, a time unit, for example, can be a symbol or a slot or sub-frame or a frame. In one example, a time-unit can be multiple symbols, or multiple slots or multiple sub-frames or multiple frames. In one example, a time-unit can be a sub-slot (e.g., part of a slot). In one example, a time-unit can be specified in units of time, e.g., microseconds, or milliseconds or seconds, etc.

In this disclosure, a frequency-unit, for example, can be a sub-carrier or a resource block (RB) or a sub-channel, wherein a sub-channel is a group of RBs, or a bandwidth part (BWP). In one example, a frequency-unit can be multiple sub-carriers, or multiple RBs or multiple sub-channels. In one example, a frequency-unit can be a sub-RB (e.g., part of a RB). A frequency-unit can be specified in units of frequency, e.g., Hz, or kHz or MHz, etc.

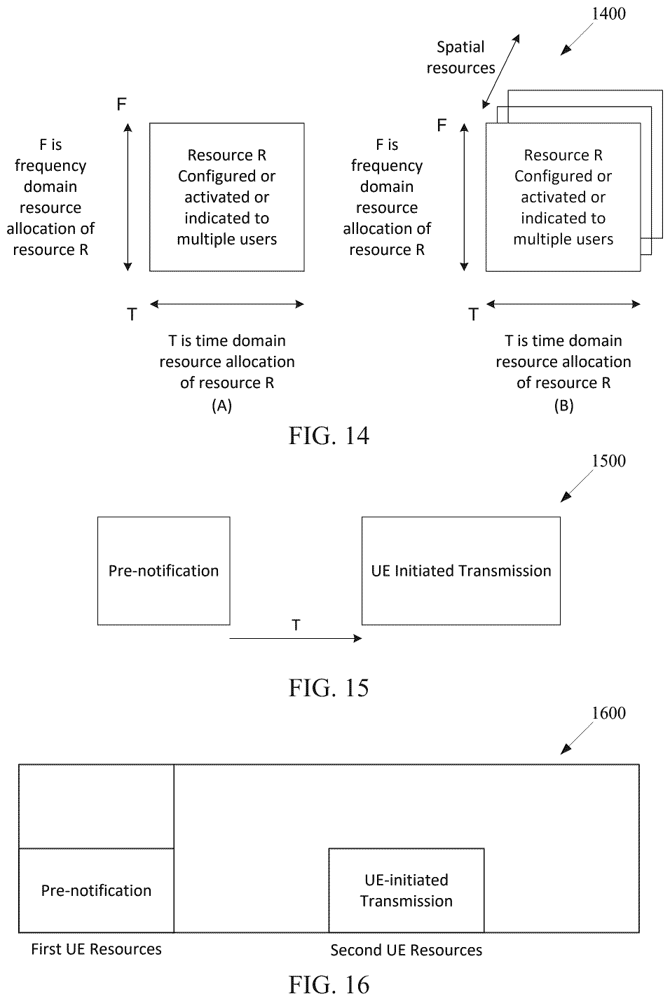

FIG. 14 illustrates an example of resources in time and frequency domains 1400 according to embodiments of the present disclosure. An embodiment of the resources in time and frequency domains 1400 shown in FIG. 14 is for illustration only.

A resource R is configured or activated or indicated for multiple users. In one example, the resource R is allocated to resources in time and frequency domains as indicated in FIG. 14 (e.g., (A) as illustrated in FIG. 14). In another example, the resource R is allocated to resources in time and frequency and spatial domains as illustrated in FIG. 14 (e.g., (B) as illustrated in FIG. 14). In one example, the time domain resource allocation of resource R is T, wherein T can be in symbols and/or slots and/or subframes and/or frames and/or time units. In one example, T determines the start and/or length and/or end of resource R in time domain. In one example, the frequency domain resource allocation of resource R is F, wherein F can be a number of sub-carriers and/or RBs and/or sub-channels (wherein a sub-channel is a group of RBs) and/or frequency units. In one example, F determines the start and/or length and/or end of resource R in frequency domain. In one example, spatial domain resource can include beam(s) or spatial domain filter(s). In one example, spatial domain resource can include antenna port(s) of reference signals (e.g., SS/PBCH blocks or CSI-RS or SRS).

In one example, spatial domain resource can include reference signals (e.g., source reference signal for quasi-co-location), (e.g., SS/PBCH blocks or CSI-RS or SRS). In one example, a reference signal is associated with (or assigned) a spatial domain resource, different reference signals are associated with (or assigned) different spatial domain resources. In one example, a spatial domain resource can be associated with a spatial domain filter (e.g., beam). In one example, a spatial domain resource can be associated with an antenna port.

In one example, resource R is configured by a higher layer signaling (e.g., RRC dedicated signaling and/or SIB signaling). In one example, resource R is activated or indicated by dynamic signaling, e.g., MAC CE signaling and/or L1 control signaling.

In one example, R comprises multiple resources, and the UE selects (e.g., autonomously and/or based on rule) a resource within the multiple resources of R. In one example, the selection of a resource in R is based on a rule. In one example, the selection of a resource in R is up to the UE's implementation (e.g., autonomously. In one example, a UE is configured multiple configurations, a UE selects a configuration from the multiple configuration for transmission. In one example, a UE is configured with multiple configured grant (CG)-PUSCH configurations, a UE selects a CG-PUSCH from the multiple CG-PUSCH configurations. In one example, a configuration or a CG-PUSCH is configured with time and/or frequency and/or spatial resources, different configurations or different CG-PUSCHes can be configured with different time and/or frequency and/or spatial resources. In one example, CG-PUSCH can be Type-1 or similar to Type-1 CG-PUSCH, e.g., configured by RRC and/or SIB signaling with no activation. In one example, CG-PUSCH can be Type-2 or similar to Type-2 CG-PUSCH, e.g., configured by RRC and/or SIB signaling with but requires activation by DCI or MAC CE and ASN.1 message before it can be used.

In one example, a configuration or a CG-PUSCH is configured with a modulation coding scheme (MCS) and/or transport block size (TBS) and/or HARQ parameters and/or MIMO parameters (e.g., number of layers), different configurations or different CG-PUSCHes can be configured with different MCS and/or TBS and/or HARQ parameters and/or MIMO parameters (e.g., number of layers). In one example, a configuration or a CG-PUSCH is configured with MCS and/or TBS and/or HARQ parameters and/or MIMO parameters (e.g., number of layers), different configurations or different CG-PUSCHes are configured with same MCS and/or TBS and/or HARQ parameters and/or MIMO parameters (e.g., number of layers)—but with different time and/or frequency and/or spatial resources. In one example, a UE determines (e.g., autonomously and/or based on rule) MCS and/or TBS and/or HARQ parameters and/or MIMO parameters (e.g., number of layers) for a configuration or a CG-PUSCH. In one example, the PN (e.g., UEI indicator) can indicate resources/MCS/payload size/HARQ parameters/MIMO parameters or Type of UE initiated transmission.

In one embodiment, a UE initiated transmission with pre-notification is provided. In one example, a UE transmits a pre-notification channel or signal (e.g., UEI indicator) before a UE initiated UL transmission as illustrated in FIG. 15.

FIG. 15 illustrates an example of pre-notification channel or signal before a UE initiated UL transmission 1500 according to embodiments of the present disclosure. An embodiment of the pre-notification channel or signal before a UE initiated UL transmission 1500 shown in FIG. 15 is for illustration only.

In one example, the pre-notification can indicate one or more of the following examples: (i) the UE transmitting the UE-initiated transmissions; (ii) the resources used for the UE-initiated transmission (e.g., time and/or frequency and/or spatial resources), e.g., the network configures multiple resources or multiple configurations or multiple CG-PUSCHes and UE selects one of the multiple resources or UE selects one of the multiple configurations or UE selects one of the multiple PUSCHes; (iii) information related to the modulation coding scheme (MCS) and/or payload size (e.g., transport block size (TBS)). In one example, the MCS and/or TBS is part of the configuration of the resources or PUSCH-CG, an indication of a resource or a configuration of resources or a CG-PUSCH indicates the MCS and/or TBS. In one example, the MCS and/or TBS is included in the UE initiated transmission of FIG. 15 (e.g., as a first part of a UE initiated transmission as described later in this disclosure); (iv) information related to HARQ (HARQ parameters), e.g., HARQ process number and/or redundancy version (RV) number. In one example, the HARQ parameters are part of the configuration of the resources or PUSCH-CG, an indication of a resource or a configuration of resources or a CG-PUSCH indicates the HARQ parameters. In one example, the HARQ parameters are included in the UE initiated transmission of FIG. 15 (e.g., as a first part of a UE initiated transmission as described later in this disclosure); and (v) information related to MIMO (MIMO parameters), e.g., number of MIMO layers, number of antenna ports, antenna ports used, or other MIMO related information. In one example, the MIMO parameters are part of the configuration of the resources or PUSCH-CG, an indication of a resource or a configuration of resources or a CG-PUSCH indicates the MIMO parameters. In one example, the MIMO parameters are included in the UE initiated transmission of FIG. 15 (e.g., as a first part of a UE initiated transmission as described later in this disclosure).

In one example, the time between the pre-notification (e.g., UEI indicator) message and UE initiated transmission is T. In one example, T can depend on UE capability.

In one example, the UE transmission resources (i.e., resources that can be used by a UE to transmit on) can be divided into the first UE resources, wherein a UE can transmit pre-notification message, and the second UE resources, where the UE can transmit UE-initiated transmissions as illustrated in FIG. 16. In one example, UE resources are UL resources. In one example, UE resources are SL resources. In one example, the allocation of the first UE resources and the second UE resources is performed periodically, wherein each instance is referred to as an occasion.

FIG. 16 illustrates an example of resource configuration for UE-initiated transmissions 1600 according to embodiments of the present disclosure. An embodiment of the UE-initiated transmissions 1600 shown in FIG. 16 is for illustration only.

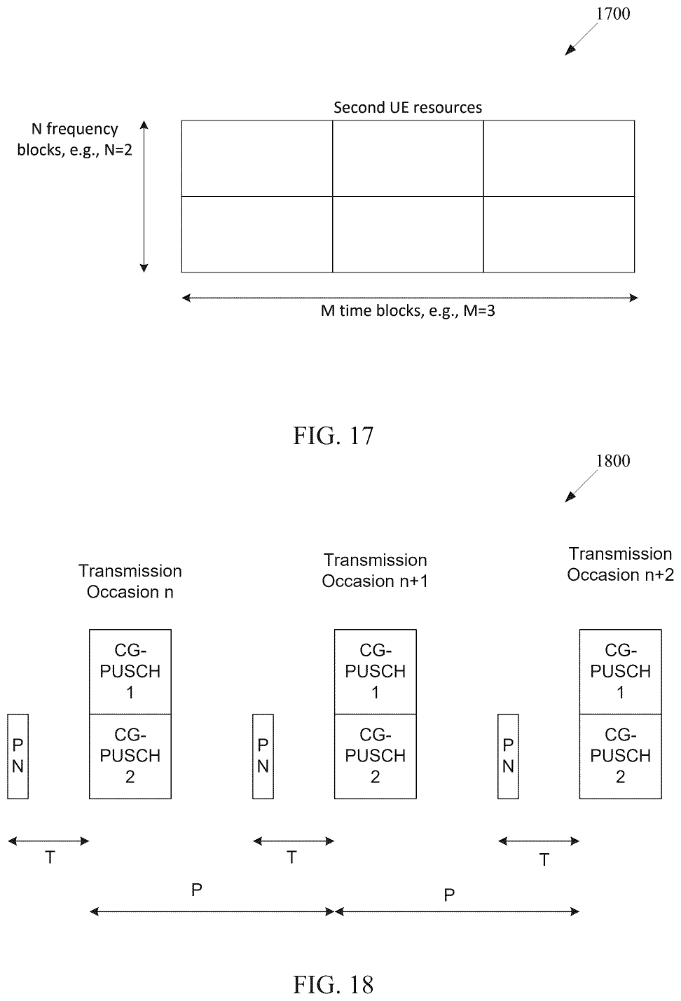

In one example, the second UE resources can be divided into blocks (e.g., multiple resources) in the frequency domain and the time domain. For example, N blocks in the frequency domain, and M blocks in the time domain, as illustrated in FIG. 17, where N=2 and M=3 as an example.

FIG. 17 illustrates an example of resource allocation 1700 according to embodiments of the present disclosure. An embodiment of the resource allocation 1700 shown in FIG. 17 is for illustration only.

In one example, the allocation of FIG. 17 is repeated/configured periodically, wherein each instance is referred to as an occasion. A frequency block can include N_{f} frequency units (e.g., resource blocks (RBs) or sub-carriers or sub-channels). A time block can include Mₜ time units (e.g., symbols or slots or sub-slots, or sub-frames, or frames). In one example, a UE can be allocated (or a UE selects for UE initiated transmission) one frequency block. In one example, a UE can be allocated (or a UE selects for UE initiated transmission) one time block. In one example, a UE can be allocated (or a UE selects for UE initiated transmission) multiple frequency blocks. In one example, a UE can be allocated (or a UE selects for UE initiated transmission) multiple time blocks. In one example, a UE can be allocated (or a UE selects for UE initiated transmission) multiple frequency blocks, and frequency blocks are contiguous in frequency. In one example, a UE can be allocated (or a UE selects for UE initiated transmission) multiple time blocks, and time blocks are contiguous in time.

In one example, frequency blocks (e.g., selected by the UE for UE initiated transmission) are indicated by a bitmap in the pre-notification message, wherein a bit can correspond to each frequency block, e.g., if there are N frequency blocks, the bitmap has N bits. In one example, time blocks (e.g., selected by the UE for UE initiated transmission) are indicated by a bitmap in the pre-notification message, wherein a bit can correspond to each time block, e.g., if there are M time blocks, the bitmap has M bits. In one example, one frequency block can be used for UE-initiated transmission, and frequency-related control information in the pre-notification message can have a size of [log 2 N], where frequency-related control information indicates the frequency block to use for the UE-initiated transmission (e.g., 0 for the first frequency block resource, 1 for the second frequency block resource, 2 for the third frequency block resource, . . . ). In one example, one time block can be used for UE-initiated transmission, and time-related control information in the pre-notification message can have a size of [log 2 M], where time-related control information indicates the time block to use for the UE-initiated transmission (e.g., 0 for the first time block resource, 1 for the second time block resource, 2 for the third time block resource, . . . ).

In one example, there are multiple configurations of resources (e.g., K configurations), or there are multiple configurations of CG-PUSCH (e.g., K CG-PUSCHes), the UE selects (e.g., autonomously and/or based on rule) one of the K configurations or one of the K CG-PUSCHes, in one example, the UE indicates one of the K configurations or K CG-PUSCHes in the pre-notification message or signal (e.g., UEI indicator), e.g., using a field of size [log 2 K]. In one example, K=2, e.g., a UE is configured with 2 configuration of resources or 2 CG-PUSCHes, when the UE initiates a transmission, the UE selects (e.g., autonomously and/or based on rule) one of the configurations or CG-PUSCHes and indicates the selected configuration or CG-PUSCH in the pre-notification message (e.g., pre-notification message has one-bit, with “0” indicating a first configuration or CG-PUSCH and “1” indicating a second configuration or CG-PUSCH). In one example, K=4, e.g., the UE is configured with 4 configuration of resources or 4 CG-PUSCHes, when the UE initiates a transmission, the UE selects (e.g., autonomously and/or based on rule) one of the configurations or CG-PUSCHes and indicates the selected configuration or CG-PUSCH in the pre-notification message (e.g., pre-notification message has two-bits, with “00” indicating a first configuration or CG-PUSCH, “01” indicating a second configuration or CG-PUSCH, “10” indicating a third configuration or CG-PUSCH and “11” indicating a fourth configuration or CG-PUSCH).

In one example, there are multiple configurations of resources (e.g., K configurations), or there are multiple configurations of CG-PUSCH (e.g., K CG-PUSCHes), the UE selects (e.g., autonomously and/or based on rule) one or more of the K configurations or one or more of the K CG-PUSCHes, in one example, the UE indicates one or more of the K configurations or K CG-PUSCHes in the pre-notification message or signal, e.g., using a using a bit of size K bits (e.g., with one bit associated with a corresponding one of the K configurations or K CG-PUSCH), in one example only one of the K bits can be one, in a variant example, more than one of the K bits can be one.

FIG. 18 illustrates an example of transmission occasion for CG-PUSCH 1800 according to embodiments of the present disclosure. An embodiment of the CG-PUSCH 1800 shown in FIG. 18 is for illustration only.

FIG. 18 illustrates an example with two configured grant configurations CG-PUSCH1 and CG-PUSCH2. An alternative example can be with more than two configured grant configurations. An alternative example can be with K configured resources. An alternative example can be with NxM frequency time blocks (e.g., as illustrated in FIG. 17). In the example, of FIG. 18, CG-PUSCH1 and CG-PUSCH2 have the same periodicity P. In a variant example, the periodicity can be different. A pre-notification message is sent before an occasion of CG-PUSCH1 and CG-PUSCH2. In one example of FIG. 18, CG-PUSCH1 and CG-PUSCH2 occur at the same time, in a variant example CG-PUSCH1 and CG-PUSCH2 can occur at different times. In one example of FIG. 18, a pre-notification message (PN) is sent a time T before CG-PUSCH1/CG-PUSCH2, in a variant example, PN can be sent time T before the earlier of CG-PUSCH1 and CG-PUSCH2, e.g., when CG-PUSCH1 and CG-PUSCH2 occur (e.g., start or end) at different times. In one example, T can be from start of PN to start of CG-PUSCH as illustrated in FIG. 18.

In one example, T can be from end of PN to start of CG-PUSCH. In one example, T can be from start of PN to end of CG-PUSCH. In one example, T can be from end of PN to end of CG-PUSCH. In one example, one PN can be associated with CG-PUSCH1 and CG-PUSCH2, for example, PN can be a bitmap with one-bit associated with CG-PUSCH1 and one-bit associated with CG-PUSCH2, a value “1” in a bit of the bitmap indicates transmission on the corresponding CG-PUSCH, in one example, a value “0” in a bit of the bitmap indicates no transmission on the corresponding CG-PUSCH, in one example, only one bit in the bitmap can have a value of “1,” in one example more than one bit in the bitmap can have a value of “1.” In one example, one PN can be associated with CG-PUSCH1 and CG-PUSCH2, for example, PN can indicate an index of CG-PUSCH with transmission, for example, “0” can indicate transmission on CG-PUSCH1, “1” can indicate transmission on CG-PUSCH2, or vice versa, in one example, if PN is not transmitted (e.g., DTX), there is no transmission on CG-PUSCH1 or CG-PUSCH2. In a variant example, there is a PN associated with each CG-PUSCH, in one example, if a PN is transmitted, there is a transmission on the corresponding CG-PUSCH, in one example, if PN is not transmitted, there is no transmission on the corresponding CG-PUSCH.

In one example, multiple frequency blocks can be used for the UE-initiated transmissions, and the multiple frequency blocks are contiguous, in one example a resource-indicator-value (RIVA)) is used to indicate the starting frequency block N_{sf} and the number of contiguous frequency blocks Nif. In one example, the RIVA value has a size of

$$⌈ {log}_{2} \frac{N ( N + 1 )}{2} ⌉ ,$$

and the RIV_{f} is given by: If

$$( {N}_{lf} - 1 ) \leq ⌊ \frac{N}{2} ⌋$$

$${RIV}_{f} = N ( {N}_{lf} - 1 ) + {N}_{sf}$$

### Else

$${RIV}_{f} = N ( N - {N}_{lf} + 1 ) + ( N - 1 - {N}_{sf} ) .$$

In one example, multiple time blocks can be used for the UE-initiated transmissions, and the multiple time blocks are contiguous, in one example a resource-indicator-value (RIVₜ) is used to indicate the starting time block M_{sf} and the number of contiguous time blocks Mir. In one example, the RIVₜ value has a size of

$$⌈ {log}_{2} \frac{M ( M + 1 )}{2} ⌉ ,$$

and the RIVₜ is given by: If

$$( {M}_{lf} - 1 ) \leq ⌊ \frac{M}{2} ⌋$$

$${RIV}_{t} = M ( {M}_{lf} - 1 ) + {M}_{sf}$$

### Else

$${RIV}_{t} = M ( M - {M}_{lf} + 1 ) + ( M - 1 - {M}_{sf} ) .$$

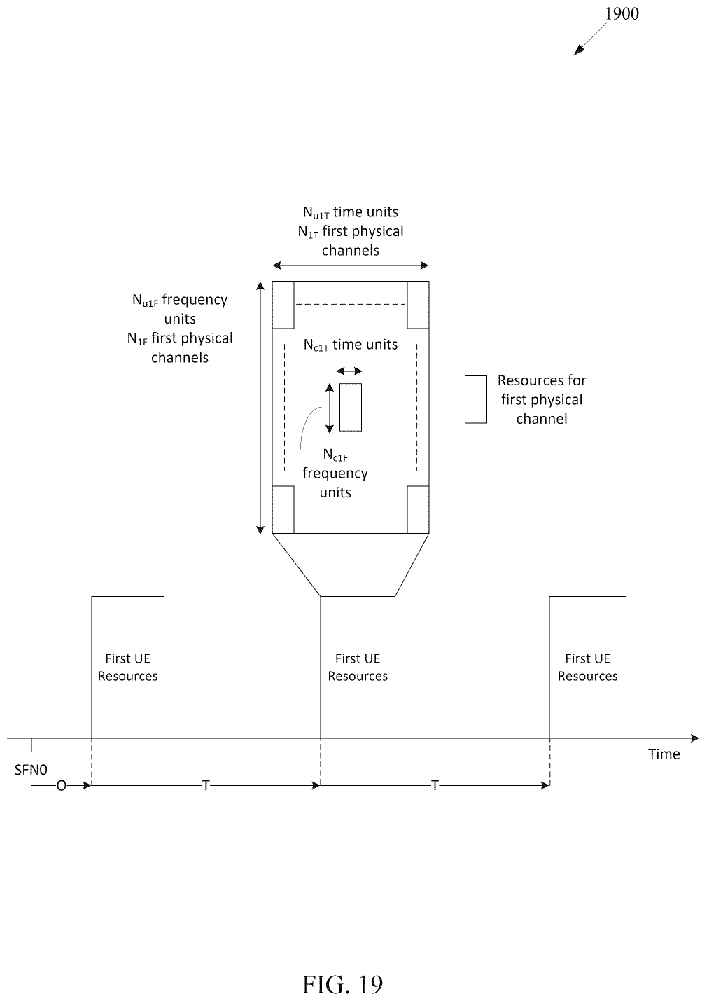

In one example, the pre-notification message is transmitted using a first physical channel(s) in the first UE resources (e.g., the first UL resources). In one example, the first UE resources are configured with a periodicity T and an offset 0, e.g., offset 0 is relative to system frame number (SFN) 0 as illustrated in FIG. 19, wherein each instance is referred to as an occasion.

FIG. 19 illustrates an example of first physical channels (e.g., for UEI indicator) in first UE resources 1900 according to embodiments of the present disclosure. An embodiment of the first physical channels in first UE resources 1900 shown in FIG. 19 is for illustration only.

The first UL resources can comprises N_{u1F} frequency units and Muir time units wherein a frequency unit can be a sub-carrier, a RB, part of a RB (e.g., a comb structure with a comb offset), or a sub-channel, and time unit can be a symbol, a sub-slot, a slot, a sub-frame or a frame. The first physical channel can have N_{c1F} frequency units and N_{c1T} time units. There can be NIF first physical channels in frequency domain, where in one example,

$${N}_{1 F} = \frac{{N}_{u 1 F}}{{N}_{c 1 F}} ,$$

where N_{u1F}is an integer multiple of N_{c1F}. In another example,

$${N}_{1 F} = ⌊ \frac{{N}_{u 1 F}}{{N}_{c 1 F}} ⌋ .$$

There can be N_{1T} first physical channels in time domain, where in one example,

$${N}_{1 T} = \frac{{N}_{u 1 T}}{{N}_{c 1 T}} ,$$

where Nᵤ₁ₜ is an integer multiple of

$${N}_{1 T} = ⌊ \frac{{N}_{u 1 T}}{{N}_{c 1 T}} ⌋ .$$

N_{c1T}. In another example, Wherein, T and/or O and/or N_{u1F} and/or N_{c1F} and/or N_{1F} and/or Nᵤ₁ₜ and/or N_{c1T} and/or N_{1T} can be defined in the system specifications and/or configured or updated by SIB signaling and/or RRC signaling and/or MAC CE signaling and/or L1 control (e.g., DCI) signaling.

In one example, one or more first physical channels (e.g., for pre-notification) are configured to convey information, as disclosed in the present disclosure, for an associated UE initiated transmission. In one example, one or more first physical channels (e.g., for pre-notification) in the first UE resources as illustrated in FIG. 19 are configured to convey information, as disclosed in the present disclosure, for an associated UE initiated transmission. In one example, one or more first physical channels (e.g., for pre-notification) in the first UE resources as illustrated in FIG. 19 and a code resource(s) within the time-frequency resources are configured to convey information, as disclosed in the present disclosure, for an associated UE initiated transmission, wherein, code resources can include cyclic shift or orthogonal cover code index in time or frequency domains.

In one example, one or more first physical channels (e.g., for pre-notification) are configured to convey information, as disclosed in the present disclosure, for an associated UE initiated transmission, wherein configuration can include time resources (e.g., offset from SFN, periodicity, duration (e.g., in symbols), symbols with a slot), frequency resources (e.g., RBs or sub-carriers, or sub-channels, or comb offset), code resources (e.g., cyclic shift or orthogonal cover code index in time or frequency domains).

In one example, the resource(s) configured for the first physical channel identify a UE. For example, a transmission on these resources is from a UE, and the network determines the UE with the corresponding UE initiated transmission. In one example, the first physical channel can be on UE-specific resources, e.g., to avoid collision between UEs.

In one example, the first physical channel can have a structure similar to PUCCH format 0 and transmitted on Uu interface in the UL direction. PUCCH format 0 can be allocated 1 or 2 symbols in the time domain, and 1 RB in the frequency domain. In one example, to convey 1-bit, the first physical channel is allocated 2 cyclic shifts. In one example, to convey 2-bits, the first physical channel is allocated 4 cyclic shifts. In one example, to convey n-bits, the first physical channel is allocated 2″ cyclic shifts, wherein a UE transmits one of the 2″ cyclic shifts. In one example, the 2″ cyclic shifts can be in different time-frequency resources.

In one example, to covey n-bits, the first physical channel is allocated 2n cyclic shifts, as n groups of 2 cyclic shifts each, wherein a UE transmits n cyclic shifts, one cyclic shift from each group. In one example, the 2n cyclic shifts can be in different time-frequency resources. In one example, the n groups of cyclic shifts are spread out over n time resources, e.g., at any time, the UE transmits one cyclic shift. In one example, there can be more than one group in the same time resource, e.g., a UE can transmit more than one cyclic shift at the same time (e.g., in different RBs or in the same RB). In one example, whether or not a UE transmits more than one cyclic shift at the same time can depend on a UE capability.

In one example, to convey n-bits, the first physical channel is allocated 4

$$⌈ \frac{n}{2} ⌉$$

cyclic shifts, as

$$⌈ \frac{n}{2} ⌉$$

groups of 4 cyclic shifts each, wherein a UE transmits

$$⌈ \frac{n}{2} ⌉$$

cyclic shifts, one cyclic shift from each group. In one example, the 4

$$⌈ \frac{n}{2} ⌉$$

cyclic shifts can be in different time-frequency resources. In one example, the

$$⌈ \frac{n}{2} ⌉$$

groups of cyclic shifts are spread out over

$$⌈ \frac{n}{2} ⌉$$

time resources, e.g., at any time, the UE transmits one cyclic shift. In one example, there can be more than one group in the same time resource, e.g., a UE can transmit more than one cyclic shift at the same time (e.g., in different RBs or in the same RB). In one example, whether or not a UE transmits more than one cyclic shift at the same time can depend on a UE capability. In one example, n is even, hence the number of cyclic shifts is 2n and the number of groups is n/2.

In one example, the first physical channel is transmitted on a SL interface using a channel similar with a structure similar to PFSCH. The mentioned examples for PUCCH format 0 can apply to PSFCH, with PSFCH replacing PUCCH format 0.

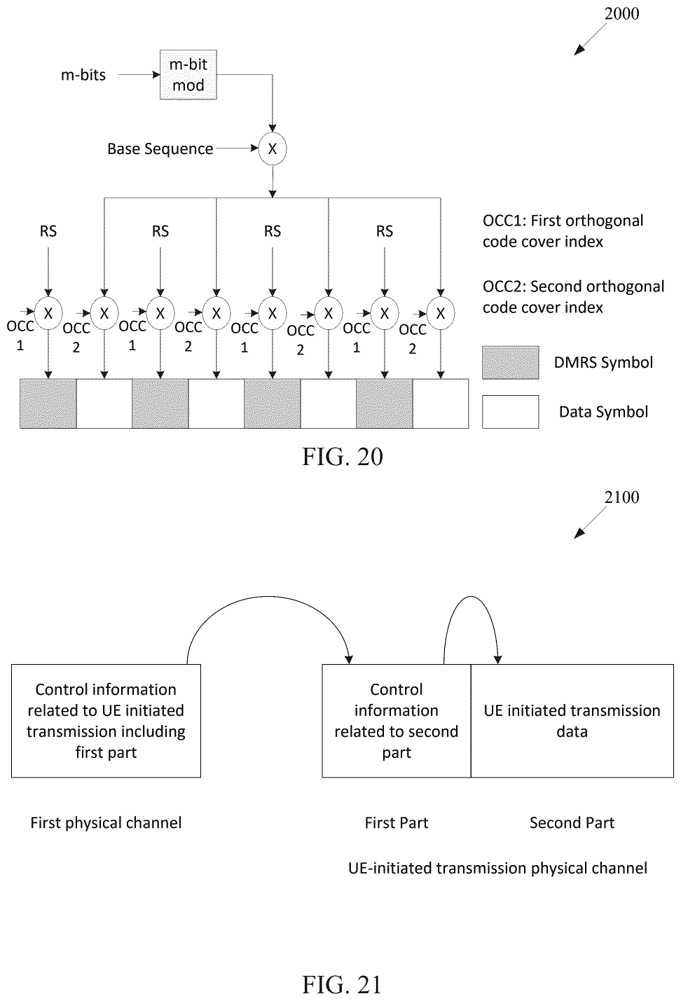

In one example, the first physical channel can have a structure similar to PUCCH format 1 and transmitted on Uu interface in the UL direction. PUCCH format 1 can be allocated M symbols in the time domain, and 1 RB in the frequency domain. In one example, M is between 4 and 14. In one example, the M symbols include DMRS symbols to assist with coherent demodulation and symbols carrying m-bits of information. In one example, the DMRS symbols are unmodulated sequences. In one example, the symbols carrying m-bits of information is a sequence modulated by m-bits as illustrated in FIG. 20.

FIG. 20 illustrates an example of symbols carrying m-bits of information 2000 according to embodiments of the present disclosure. An embodiment of the symbols carrying m-bits of information 2000 shown in FIG. 20 is for illustration only.

In one example, m=1, the one-bit information is BPSK modulated and multiplied to a base sequence. In one example, m=2, the 2-bit information is QPSK modulated and multiplied to a base sequence. In one example, m=3, the 3-bit information is 8-PSK modulated and multiplied to a base sequence. In one example, m=4, the 4-bit information is 16-QAM modulated and multiplied to a base sequence. In one example, m=m′, the m′-bit information is 2^{m′}-QAM modulated and multiplied to a base sequence.

In one example, to convey n-bits, there are N first physical channels, where

$$N = ⌈ \frac{n}{m} ⌉ .$$

In one example, n is a multiple of m, and

$$N = \frac{n}{m}$$

In one example, a UE transmits each of the N first physical channels, each carrying m-bits of information. In one example, the N physical channels are spread out over N time resources, e.g., at any time, the UE transmits one first physical channel. In one example, there can be more than one first physical channel in the same time resource, e.g., UE can transmit more than one first physical channel at the same time (e.g., in different RBs). In one example, whether or not a UE transmits more than one first physical channel at the same time can depend on a UE capability. In one example, the N first physical channels are contiguous in time.

In one example, m=1, and to convey n-bits of information, there are N=n first physical channels. In one example, m=2, and to convey n-bits of information, there are

$$N = ⌈ \frac{n}{2} ⌉ or N = \frac{n}{2} ,$$

when n is even, first physical channels.

In one example, the first physical channel can have a structure similar to PUCCH format 4 and transmitted on Uu interface in the UL direction. PUCCH format 4 can be allocated M symbols in the time domain, and 1 RB in the frequency domain. In one example, M is between 4 and 14. In one example, the first physical channel can carry n-bits of information.

In one example, the first physical channel can have a structure similar to PUCCH format 2 or PUCCH format 3 and transmitted on Uu interface in the UL direction. PUCCH format 2 or PUCCH format 3 can be allocated M symbols in the time domain, and K RBs in the frequency domain. In one example, the first physical channel can carry n-bits of information.

In one example, the first physical channel can be transmitted in the SL interface and can have a structure similar to PUCCH format 1 or PUCCH format 2 or PUCCH format 3 or PUCCH format 4.

In one example, the first physical channel can use a structure similar to PUSCH, e.g., when the UE transmission is on Uu interface in the UL direction. In one example, the first physical channel can use a structure similar to PUCCH format designed for 6G for small payloads, e.g., when the UE transmission is on Uu interface in the UL direction. In one example, the first physical channel can use a structure similar to PUCCH format designed for 6G for large payloads, e.g., when the UE transmission is on Uu interface in the UL direction.

In one example, the first physical channel can be transmitted in the SL interface and can have a structure similar to PSCCH. In one example, the first physical channel can be transmitted in the SL interface and can have a structure similar to PSCCH/PSSCH.

In one example, the UE-initiated transmission can be performed on an Uu interface in the UL direction. In one example, the UE-initiated transmission can be performed on a channel similar to PUSCH. In one example, the UE-initiated transmission can be performed on a channel similar to PUCCH. In one example, the UE-initiated transmission can include two parts.

In one example, the UE initiated transmission can be on the SL interface. In one example, the UE-initiated transmission can be on a channel similar to PSSCH. In one example, the UE-initiated transmission can be on channels similar to PSSCH/PSCCH.

In one example, the two parts are separately encoded, and multiplexed on the same physical channel. In one example, the first part includes information that assists in decoding the second part (e.g., MCS and/or TBS and/or HARQ parameters as disclosed in the present disclosure, and/or MIMO parameters as disclosed in the present disclosure). In one example, the resources used for the first part are indicated in the first physical channel (e.g., pre-notification) as illustrated in FIG. 21.

FIG. 21 illustrates an example of UE initiated transmission with a first part and a second part 2100 according to embodiments of the present disclosure. An embodiment of the UE initiated transmission with a first part and a second part 2100 shown in FIG. 21 is for illustration only.

In one example, the resources used for the first part are pre-configured. In one example, the PN can indicate resources for UE initiated transmission, or whether there is a UE initiated transmission, the UE initiated transmission has two parts, wherein the first has a pre-determined (e.g., by specification or configuration) allocation and format and the first part indicates information to assist with the decoding of the second part. In one example, the information included in the first part can include: (i) information related to the modulation coding scheme (MCS) and/or payload size (e.g., transport block size (TBS)), e.g., for the second part; (ii) information related to HARQ, e.g., HARQ process number and/or redundancy version (RV) number, e.g., for the second part; and (iii) information related to MIMO, e.g., number of MIMO layers, number of antenna ports, antenna ports used, or other MIMO related information, e.g., for the second part.

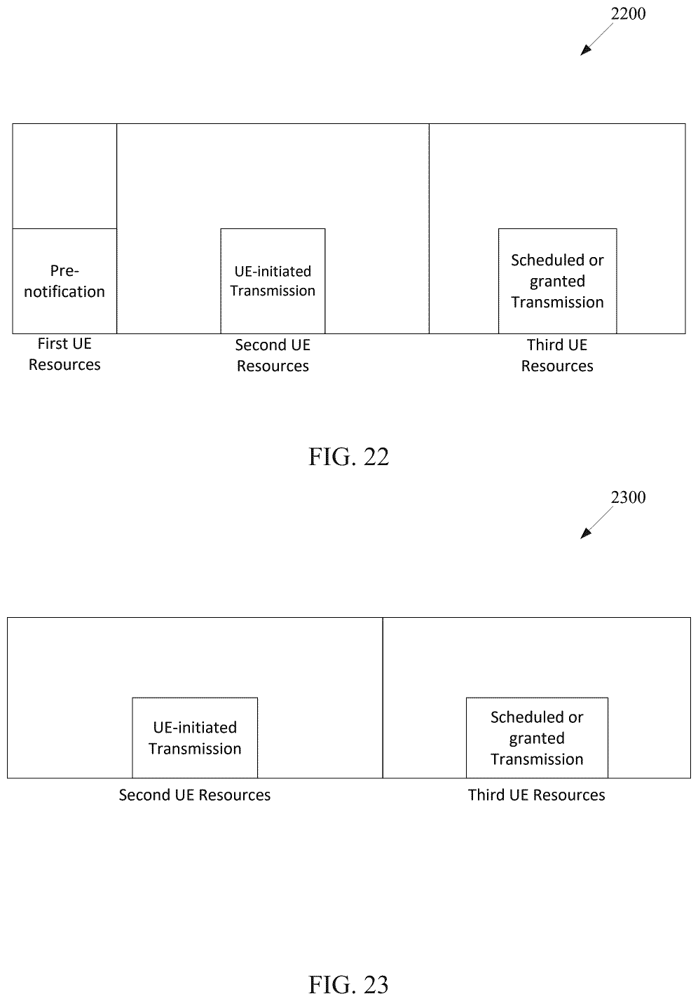

In one example, the mentioned information (or some of the mentioned) is included in the first physical channel. In one example, the mentioned information (or some of the mentioned) can be pre-configured. In one example, there is no first part, or a subset of the aforementioned information is included in the first part. In one example, the UE initiated transmission can include one or more frequency blocks and one or more time blocks indicated in pre-notification (e.g., first physical channel) as disclosed in the present disclosure. In one example, the UE transmission resources (i.e., resources that can be used by UE to transmit on) can be divided into the first UE resources, wherein a UE can transmit pre-notification message, the second UE resources, wherein a UE can transmit UE-initiated transmissions, and the third UE resources wherein UE can transmit scheduled (or granted) transmissions as illustrated in FIG. 22.

FIG. 22 illustrates an example of UE transmission resources used for pre-notification, UE initiated transmissions, scheduled transmissions 2200 according to embodiments of the present disclosure. An embodiment of the UE transmission resources used for pre-notification, UE initiated transmissions, scheduled transmissions 2200 shown in FIG. 22 is for illustration only.

In one example, the scheduled or granted transmissions are scheduled or granted by the network. In one example, the scheduled or granted transmissions are scheduled or granted by another device (e.g., UE). In one example, UE resources are UL resources. In one example, UE resources are SL resources. In one example, the allocation of the first UE resources, the second UE resources and the third UE resources is allocated periodically, wherein each instance is referred to as an occasion.

In a variant example, there are no first UE resources. The UE transmission resources (i.e., resources that can be used by the UE to transmit on) can be divided into, the second UE resources, wherein the UE can transmit UE-initiated transmissions, and the third UE resources wherein the UE can transmit scheduled (or granted) transmissions as illustrated in FIG. 23.

FIG. 23 illustrates example of UE transmission resources used for UE initiated transmissions, scheduled transmissions 2300 according to embodiments of the present disclosure. An embodiment of the UE transmission resources used for the UE initiated transmissions, scheduled transmissions 2300 shown in FIG. 23 is for illustration only.

In one example, the scheduled or granted transmissions are scheduled or granted by the network. In one example, the scheduled or granted transmissions are scheduled or granted by another device (e.g., UE). In one example, UE resources are UL resources. In one example, UE resources are SL resources. In one example, the allocation of second UE resources and the third UE resources is allocated periodically, wherein each instance is referred to as an occasion.

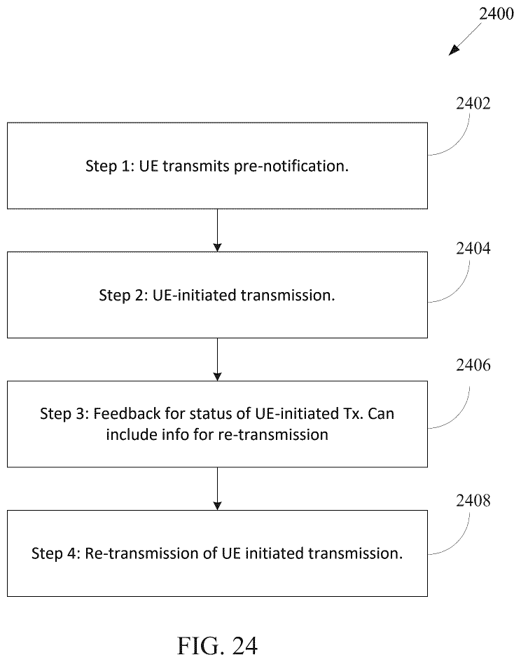

FIG. 24 illustrates a flowchart of method 2400 for retransmission of UE initiated transmission according to embodiments of the present disclosure. The method 2400 as may be performed by a UE (e.g., 111-116 as illustrated in FIG. 1). An embodiment of the method 2400 shown in FIG. 24 is for illustration only. One or more of the components illustrated in FIG. 24 can be implemented in a specialized circuitry configured to perform the noted functions or one or more of the components can be implemented by one or more processors executing instructions to perform the noted functions.

In one example, a UE transmits a pre-notification message, as illustrated in step 1 (e.g. step 2402) of FIG. 24. A UE transmits a UE-initiated message as illustrated in step 2 (e.g., step 2404) of FIG. 24. Wherein, the pre-notification message can indicate resources and possibly other control information for the UE-initiated transmission. In one example, the pre-notification message can indicate information related to MCS and/or TBS and/or HARQ related parameters and/or MIMO related parameters for the UE-initiated transmission. In one example, UE-initiated transmission is one-part. In one example, the UE-initiated transmission is two parts. In one example, the first part of the UE-initiated transmissions includes information for the second part of the UE-initiated transmission. In one example, the first-part of the UE-initiated transmission can indicate information related to MCS and/or TBS and/or HARQ related parameters and/or MIMO related parameters for the second-part of the UE-initiated transmission. In a variant example, the pre-notification message is not transmitted, the UE transmits the UE-initiated transmission without a pre-notification message.

In one example, in response to the UE-initiated transmission, the UE receives feedback information as illustrated in step 3 (e.g., step 2406) of FIG. 24. In one example, the feedback information is transmitted by the network (e.g., gNB), e.g., when UE-initiated transmission is on UL. In one example, the feedback information is transmitted by another device, e.g., when UE-initiated transmission is on SL. In one example, the feedback information includes acknowledgement on whether the UE-initiated transmission has been successfully received and decoded or not (e.g., HARQ-ACK feedback). In one example, the feedback information includes information to assist with the re-transmission of the UE-initiated transmission in case it has not been successfully received, e.g., information related to MCS and/or TBS and/or HARQ related parameters and/or MIMO related parameters for the re-transmission. In one example, the feedback is transmitted in DCI format or MAC CE or ASN. 1 message, e.g., when UE-initiated transmission is on UL. In one example, the DCI format is transmitted to the UE (e.g., UE specific DCI format).

In one example, the DCI format is transmitted to a group of UEs (e.g., group common (GC)-DCI format). In one example, for GC-DCI, a UE is configured a bit field within the GC-DCI payload, wherein information is conveyed to the UE e.g., information related to HARQ-ACK feedback and/or re-transmission or new transmission parameters. In one example, the feedback is transmitted in a PSFCH, e.g., when UE-initiated transmission is on SL. In one example, the feedback is transmitted in SL control information (SCI), e.g., on PSCCH and/or on PSSCH, e.g., when UE-initiated transmission is on SL.

In one example, in response to the feedback information of step 3 (e.g., 2406), a UE re-transmits the UE-initiated transmission, e.g., a UE retransmits the UE-initiated transmission if it has not been successfully received by the network. This is illustrated in step 4 (e.g., step 2408) of FIG. 24. In one example, in response to the feedback information of step 3 (e.g., 2406), the UE can transmit a new UE-initiated transmission (e.g., additional information associated with or after first UE initiated transmission), e.g., if previously UE-initiated transmission is indicated as being successfully received. In one example, if the UE does not receive any feedback for a UE-initiated transmission, the UE can re-transmit the UE initiated transmission. In one example, the re-transmission is in the second UE resources (e.g., UE initiated transmission) as illustrated in FIG. 16. In one example, the re-transmission, includes sending a per-notification in first resources followed by UL transmission in second resources.

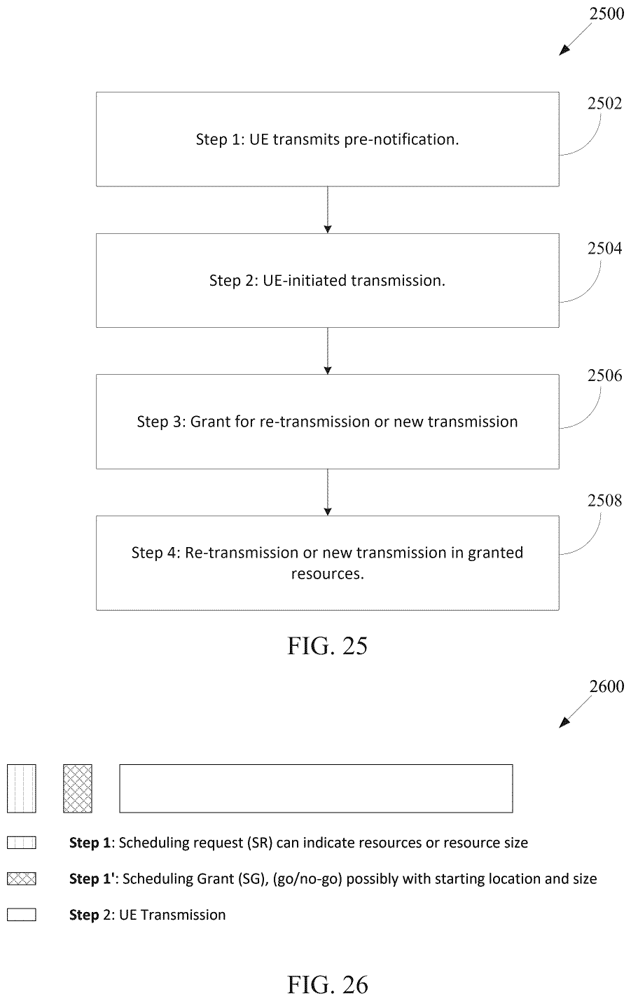

FIG. 25 illustrates a flowchart of method 2500 for retransmission or new transmission in granted resources according to embodiments of the present disclosure. The method 2500 as may be performed by a UE (e.g., 111-116 as illustrated in FIG. 1). An embodiment of the method 2500 shown in FIG. 25 is for illustration only. One or more of the components illustrated in FIG. 25 can be implemented in a specialized circuitry configured to perform the noted functions or one or more of the components can be implemented by one or more processors executing instructions to perform the noted functions.

In one example, a UE transmits a pre-notification message, as illustrated in step 1 (e.g. step 2502) of FIG. 25. A UE transmits a UE-initiated message as illustrated in step 2 (e.g., step 2504) of FIG. 25. Wherein, the pre-notification message can indicate resources and possibly other control information for the UE-initiated transmission. In one example, the pre-notification message can indicate information related to MCS and/or TBS and/or HARQ related parameters and/or MIMO related parameters for the UE-initiated transmission. In one example, UE-initiated transmission is one-part. In one example, the UE-initiated transmission is two parts. In one example, the first part of the UE-initiated transmissions includes information for the second part of the UE-initiated transmission. In one example, the first-part of the UE-initiated transmission can indicate information related to MCS and/or TBS and/or HARQ related parameters and/or MIMO related parameters for the second-part of the UE-initiated transmission. In a variant example, the pre-notification message is not transmitted, the UE transmits the UE-initiated transmission without a pre-notification message.

In one example, in response to the UE-initiated transmission, the UE receives a grant to re-transmit the UE-initiated transmission, for example if the UE-transmission has not been successfully received, as illustrated in step 3 (e.g., step 2506) of FIG. 25. In one example, the grant includes information related to resources of the re-transmission and other information control information for the re-transmission, e.g., information related to MCS and/or TBS and/or HARQ related parameters and/or MIMO related parameters for the re-transmission. In one example, the re-transmission includes one part. In one example, the grant includes information related to resources of the re-transmission. In one example, the re-transmission is two parts, wherein the first part includes information related to the second part of the re-transmission. In one example, the first-part of the re-transmission can indicate information related to MCS and/or TBS and/or HARQ related parameters and/or MIMO related parameters for the second-part of the re-transmission.

In one example, the grant includes information related to resources of a new transmission (e.g., additional information associated with or following first UE initiated transmission) and other information control information for the new transmission, e.g., information related to MCS and/or TBS and/or HARQ related parameters and/or MIMO related parameters for the new transmission. In one example, the new transmission includes one part. In one example, the grant includes information related to resources of the new transmission. In one example, the new transmission is two parts, wherein the first part includes information related to the second part of the new transmission. In one example, the first-part of the new transmission can indicate information related to MCS and/or TBS and/or HARQ related parameters and/or MIMO related parameters for the second-part of the new transmission.

In one example, the grant is transmitted in DCI format or MAC CE or ASN.1 message, e.g., when UE-initiated transmission is on UL. In one example, the DCI format is transmitted to the UE (e.g., UE specific DCI format). In one example, the DCI format is transmitted to a group of UEs (e.g., group common (GC)-DCI format). In one example, for GC-DCI, a UE is configured with a bit field within the GC-DCI payload, wherein information is conveyed to the UE e.g., information related re-transmission or new transmission parameters. In one example, the grant is transmitted in SL control information (SCI), e.g., on PSCCH and/or on PSSCH, e.g., when UE-initiated transmission is on SL.

In one example, in response to the grant information of step 3, a UE re-transmits the UE-initiated transmission, e.g., the UE retransmits the UE-initiated transmission if the UE has not been successfully received by the network. This is illustrated in step 4 (e.g., step 2508) of FIG. 25. In one example, in response to the grant information of step 3 (e.g., 2506), the UE can transmit a new transmission (e.g., additional information associated with or following first UE initiated transmission), e.g., if previously UE-initiated transmission is indicated as being successfully received. In one example, the transmission (re-transmission or new transmission) is in the third UE resources (e.g., resources scheduled by network) as illustrated in FIG. 23.

In one embodiment, a UE initiated transmission with conformation from the network is provided.

FIG. 26 illustrates an example of UE transmission 2600 according to embodiments of the present disclosure. An embodiment of the UE transmission 2600 shown in FIG. 26 is for illustration only.

In one example, a UE has data to transmit. In one example, the transmission can be on a Uu interface in the UL direction. In one example, the transmission can be a SL interface. In one example, the UE sends a scheduling request (SR) or pre-notification (PN) message/signal as illustrated in step 1 of FIG. 26. In one example, the SR is similar to the mentioned pre-notification (PN) message/signal, and the mentioned examples of pre-notification message apply to the SR or PN. In one example, the UE receives a scheduling grant (SG) (e.g., go/no-go signal) as illustrated in step 1 of FIG. 26. In one example, the SG is a go or no-go message/signal for the UE transmission. In one example, the scheduling grant is from a network (e.g., gNB), when the UE transmission is on the Uu interface in the UL direction. In one example, SG (e.g., go/no-go signal) is transmitted in signal with structure similar to PUCCH format 0 or PUCCH format 1, as aforementioned, on the DL. In one example, SG (e.g., go/no-go signal) is transmitted in a DCI format or MAC CE or ANS.1 message. In one example, the scheduling grant is from another device (e.g., UE), when the UE transmission is on SL.

In one example, SG (e.g., go/no-go signal) is transmitted in a PSFCH. In one example, SG (e.g., go/no-go signal) is transmitted in SL control information (SCI), e.g., on PSCCH and/or on PSSCH. In one example, in response to the scheduling grant, the UE proceeds with a UE transmission as illustrated in step 2 of FIG. 26. In one example, the UE transmission is similar to the mentioned UE-initiated transmission.

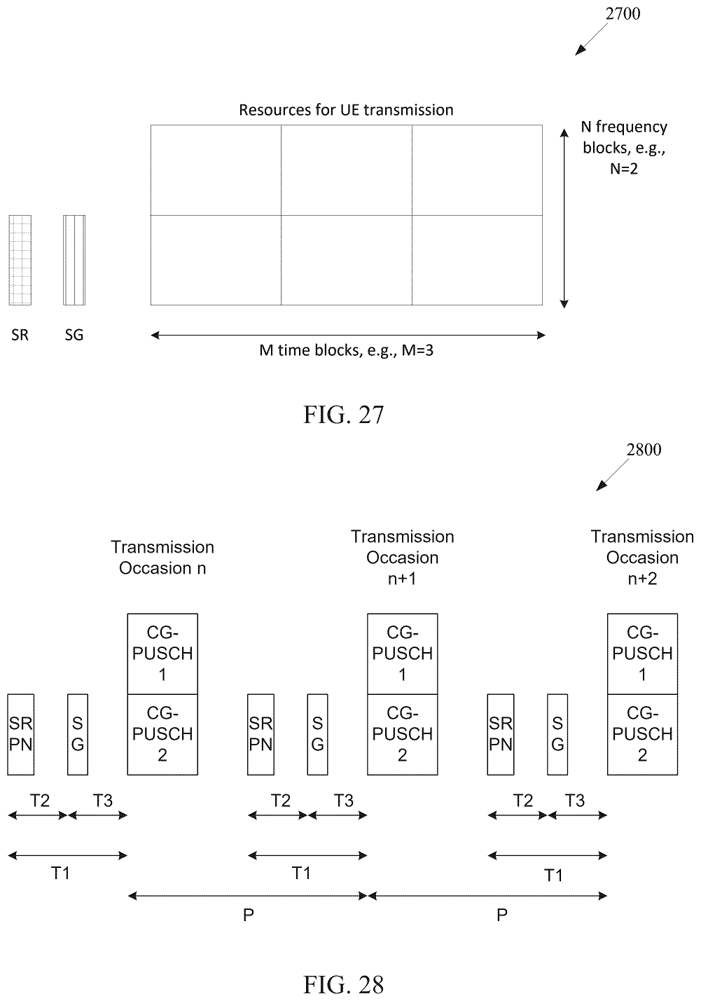

FIG. 27 illustrates another example of UE transmission 2700 according to embodiments of the present disclosure. An embodiment of the UE transmission 2700 shown in FIG. 27 is for illustration only.

In one example, the UE transmission region can be divided into multiple resources in the time and frequency domains, e.g., N frequency blocks and M time blocks as illustrated in FIG. 27. In one example, the UE can transmit in one resource in the “resources for UE transmission” of FIG. 27. In one example, the UE can transmit in multiple resources in the “resources for UE transmission” of FIG. 27. In one example, the allocation of FIG. 27 is repeated/configured periodically, wherein each instance is referred to as an occasion. In one example, the UE is allocated K resources or K CG-PUSCH.

In one example, the SR or PN is transmitted in the first UE resources of FIG. 16 or FIG. 22. In one example, the UE transmission is transmitted in the second UE resources of FIG. 16, FIG. 22, or FIG. 23.

In one example, the SR or PN can indicate the number of resources the UE is requesting in the “resources for UE transmission.” In one example, the SR or PN can indicate a request for transmission. In one example, the SG can indicate the resources or configuration or CG-PUSCH UE is granted to transmitted on. In one example, the resources (in SG) are indicated as a bitmap for frequency resources, e.g., a size of bitmap is N bits. In one example, the resources (in SG) are indicated as a bitmap for time resources, e.g., a size of bitmap is M bits. In one example, the resources (in SG) are indicated as a bitmap for frequency resources+a bitmap for time resources, e.g., size of bitmap is N+M bits. In one example, the resources (in SG) are indicated as a bitmap for frequency resources and time resources, e.g., a size of bitmap is M× N bits. In one example, the resources (in SG) are indicated as a resource indicator value (RIV) for frequency resources,

$$⌈ {log}_{2} \frac{N ( N + 1 )}{2} ⌉ bits ,$$

e.g., size of field is as aforementioned.

In one example, the resources (in SG) are indicated as a resource indicator value (RIV)

$$⌈ {log}_{2} \frac{M ( M + 1 )}{2} ⌉ bits ,$$

for time resources, e.g., size of field is as aforementioned. In one examples, the resources (in SG) are indicated as a resource indicator value (RIV) for frequency resources+a resource indicator value (RIV) for time resources, e.g., size of field for time and frequency is

$$⌈ {log}_{2} \frac{N ( N + 1 )}{2} ⌉ + ⌈ {log}_{2} \frac{M ( M + 1 )}{2} ⌉ bits ,$$

each group of bits for an RIV value is as aforementioned. In one examples, the resources (in SG) are indicated as a resource indicator value (RIV) for frequency

$$⌈ {log}_{2} \frac{NM ( NM + 1 )}{2} ⌉ bits ,$$

resources and time resources, e.g., size of bitmap is for a combined number of resources of NM, the RIV is determined as aforementioned, in one example, the resources are ordered in time first and then order in frequency, in one example, the resources are ordered in frequency first and then in time. In one example, if a UE is configured with K configurations of resources or K CG-PUSCH, the SG can indicate one of the K configurations or one of the K CG-PUSCHes, e.g., using a field of size [log 2 K]. In one example, if a UE is configured with K configurations of resources or K CG-PUSCH, the SG can indicate one or more of the K configurations or one of the K CG-PUSCHes, e.g., using a field of size K bits (e.g., with one bit associated with one of the K configurations or K CG-PUSCH), in one example only one of the K bits can be one, in a variant example, more than one of the K bits can be one.

In one example, the SR or PN can indicate the resources the UE is requesting in the “resources for UE transmission” or from the K configurations or K CG-PUSCHes (e.g., similar to mentioned pre-notification message/signal). In one example, the SG can indicate whether or not to proceed with UE transmission (e.g., go/no-go signal). In one example, the resources (e.g., selected by the UE for UE initiated transmission) (in SR or PN) are indicated as a bitmap for frequency resources (e.g., as illustrated in FIG. 27), e.g., a size of bitmap is N bits. In one example, the resources (e.g., selected by the UE for UE initiated transmission) (in SR or PN) are indicated as a bitmap for time resources (e.g., as illustrated in FIG. 27), e.g., a size of bitmap is M bits. In one example, the resources (e.g., selected by the UE for UE initiated transmission) (in SR or PN) are indicated as a bitmap for frequency resources+a bitmap for time resources, e.g., size of bitmap is N+M bits.

In one example, the resources (e.g., selected by the UE for UE initiated transmission) (in SR or PN) are indicated as a bitmap for frequency resources and time resources, e.g., a size of bitmap is M×N bits. In one example, one frequency block can be used for UE-initiated transmission, and frequency-related control information in the SR or PN can have a size of [log 2 N] as disclosed in the present disclosure. In one example, one time block can be used for UE-initiated transmission, and time-related control information in the SR or PN can have a size of [log 2 M] as disclosed in the present disclosure. In one example, one time block and one frequency block can be used for UE-initiated transmission, and time/frequency-related control information in the SR or PN can have a size of [log 2 NM] or [log 2 N]+[log 2 M].

In one example, multiple frequency blocks/resources can be used for the UE-initiated transmissions, and the multiple frequency blocks/resources are contiguous, in one example the resources (e.g., selected by the UE for UE initiated transmission) (in SR or PN) are indicated as a resource indicator value (RIV) for frequency resources, as aforementioned, e.g., a size of field is

$$⌈ {log}_{2} \frac{N ( N + 1 )}{2} ⌉ bits .$$

In one example, multiple time blocks/resources can be used for the UE-initiated transmissions, and the multiple time blocks/resources are contiguous, in one example the resources (e.g., selected by the UE for UE initiated transmission) (in SR or PN) are indicated as a resource indicator value (RIV) for time resources, as aforementioned, e.g., size of field is

$$⌈ {log}_{2} \frac{M ( M + 1 )}{2} ⌉ bits .$$

In one example, multiple frequency/time blocks/resources can be used for the UE-initiated transmissions, and the multiple frequency/time blocks/resources are contiguous, in one example the resources (e.g., selected by the UE for UE initiated transmission) (in SR or PN) are indicated as a resource indicator value (RIV) for frequency resources, as aforementioned+a resource indicator value (RIV) for time resources as aforementioned, e.g., size of field for time and frequency is

$$⌈ {log}_{2} \frac{N ( N + 1 )}{2} ⌉ + ⌈ {log}_{2} \frac{M ( M + 1 )}{2} ⌉ bits .$$

In one examples, multiple frequency/time blocks/resources can be used for the UE-initiated transmissions, and the multiple frequency/time blocks/resources are contiguous, in one example the resources (e.g., selected by the UE for UE initiated transmission) (in SR or PN) are indicated as a resource indicator value (RIV) for frequency resources and time resources, e.g., size of bitmap is

$$⌈ {log}_{2} \frac{NM ( NM + 1 )}{2} ⌉ bits ,$$

for a combined number of resources of NM, the RIV is determined as aforementioned, in one example, the resources are ordered in time first and then in frequency, in one example, the resources are ordered in frequency first and then in time.

In one example, there may be multiple configurations of resources (e.g., K configurations), or there are multiple configurations of CG-PUSCH (e.g., K CG-PUSCHes), the UE selects (e.g., autonomously and/or based on rule) one of the K configurations or one of the K CG-PUSCHes in the SR or PN, e.g., using a field of size [log 2 K].

In one example, there are multiple configurations of resources (e.g., K configurations), or there are multiple configurations of CG-PUSCH (e.g., K CG-PUSCHes), the UE selects (e.g., autonomously and/or based on rule) one or more of the K configurations or one or more of the K CG-PUSCHes, e.g., using a using a bit of size K bits (e.g., with one bit associated with one of the K configurations or K CG-PUSCH) in the SR or PN, in one example only one of the K bits can be one, in a variant example, more than one of the K bits can be one.

In one example, the SR or PN can use a structure similar to PUCCH format 0 or PUCCH format 1 or PUCCH format 2 or PUCCH format 3 or PUCCH format 4, when the UE transmission is on Uu interface in the UL direction. In one example, the SR or PN can use a structure similar to PUSCH, e.g., when the UE transmission is on Uu interface in the UL direction. In one example, the SR or PN can use a structure similar to PUCCH format designed for 6G for small payloads, e.g., when the UE transmission is on Uu interface in the UL direction. In one example, the first SR or PN can use a structure similar to PUCCH format designed for 6G for large payloads, e.g., when the UE transmission is on Uu interface in the UL direction. In one example, the SR can use a structure to PSFCH or use sidelink control information (SCI), e.g., on PSCCH and/or on PSSCH, when the UE transmission is on SL interface. The aforementioned examples, for pre-notification can apply to SR.

In one example, the SG (e.g., go/no-go signal) is transmitted in DCI format or MAC CE or ASN.1 message, e.g., when UE transmission is on UL. In one example, the DCI format is transmitted to the UE (e.g., UE specific DCI format). In one example, the DCI format is transmitted to a group of UEs (e.g., group common (GC)-DCI format). In one example, for GC-DCI, a UE is configured a bit field within the GC-DCI payload, wherein information is conveyed to the UE e.g., information related to related to go/no-go signal and/or resource indication as described in this disclosure. In one example, the SG is transmitted in a PSFCH, e.g., when UE transmission is on SL. In one example, the SG is transmitted in SL control information (SCI), e.g., on PSCCH and/or on PSSCH, e.g., when UE transmission is on SL.

In one example, the SG can include or indicate one or more of the following information: (i) the UE transmitting the UE transmissions; (ii) the resources used for the UE transmission (e.g., time and/or frequency resources); (iii) information related to the modulation coding scheme (MCS) and/or payload size (e.g., transport block size (TBS)); (iv) information related to HARQ, e.g., HARQ process number and/or redundancy version (RV) number; and/or (v) information related to MIMO, e.g., number of MIMO layers, or number of antenna ports, or antenna ports used, or other MIMO related information.

In one example, the UE transmission is a one-part UE transmission. In one example, the UE transmission is two parts. In one example, the two parts are separately encoded, and multiplexed on the same physical channel (e.g., UE transmission). In one example, the first part includes information that assists in decoding the second part. In one example, the resources and/or coding parameters (e.g., MCS/TBS/HARQ information/MIMO information) used for the first part are indicated SR and/or SG. In one example, the resources and/or coding parameters used for the first part are pre-configured.

In one example, the information included in the first part can include: (i) information related to the modulation coding scheme (MCS) and/or payload size (e.g., transport block size (TBS)); (ii) information related to HARQ, e.g., HARQ process number and/or redundancy version (RV) number; and/or (iii) information related to MIMO, e.g., number of MIMO layers, or number of antenna ports, or antenna ports used or other MIMO related information for the second part.

FIG. 28 illustrates an example of UE transmission with 2 CG-PUSCH configurations 2800 according to embodiments of the present disclosure. An embodiment of the UE transmission with 2 CG-PUSCH configurations 2800 shown in FIG. 28 is for illustration only.

FIG. 28 illustrates an example with two configured grant configurations CG-PUSCH1 and CG-PUSCH2. An alternative example can be with more than two configured grant configurations. An alternative example can be with K configured resources. An alternative example can be with NxM frequency time blocks (e.g., as illustrated in FIG. 27). In the example of FIG. 28, CG-PUSCH1 and CG-PUSCH2 have the same periodicity P. In a variant example, the periodicity can be different.

A SR or PN is sent before an occasion of CG-PUSCH1 and CG-PUSCH2. In one example of FIG. 28, CG-PUSCH1 and CG-PUSCH2 occur at the same time, in a variant example CG-PUSCH1 and CG-PUSCH2 can occur at different times. In one example of FIG. 28, a SR or PN is sent a time T before CG-PUSCH1/CG-PUSCH2, in a variant example, SR or PN can be sent time T before the earlier of CG-PUSCH1 and CG-PUSCH2, e.g., when CG-PUSCH1 and CG-PUSCH2 occur (e.g., start or end) at different times. In one example, T1 can be from start of SR or PN to start of CG-PUSCH as illustrated in FIG. 28. In one example, T1 can be from end of SR or PN to start of CG-PUSCH. In one example, T1 can be from start of SR or PN to end of CG-PUSCH. In one example, T1 can be from end of SR or PN to end of CG-PUSCH.

In one example, the SR or PN can indicate the resource a UE intends to transmit one. In one example, the SR or PN can indicate a request from a UE to transmit on one of the resources of this occasion. In one example, one SR or PN can be associated with CG-PUSCH1 and CG-PUSCH2, for example, SR or PN can be a bitmap with one-bit associated with CG-PUSCH1 and one-bit associated with CG-PUSCH2, a value “1” in a bit of the bitmap indicates transmission on the corresponding CG-PUSCH, in one example, a value “0” in a bit of the bitmap indicates no transmission on the corresponding CG-PUSCH, in one example, only one bit in the bitmap can have a value of “1,” in one example more than one bit in the bitmap can have a value of “1.” In one example, the role of “1” and “0” can be reversed (this applies generally in this disclosure). In one example, the SR or PN can be a signal indicating whether or not the UE wants (or has data) to transmit on this occasion, in one example, if the SR or PN is transmitted there is a request for transmission in this occasion, in one example, if SR or PN is not transmitted, there is no request for transmission in this occasion.

In one example, one SR or PN can be associated with CG-PUSCH1 and CG-PUSCH2, for example, SR or PN can indicate an index of CG-PUSCH with transmission, for example, “0” can indicate transmission on CG-PUSCH1, “1” can indicate transmission on CG-PUSCH2, or vice versa, in one example, if PN is not transmitted (e.g., DTX), there is no transmission on CG-PUSCH1 or CG-PUSCH2. In a variant example, there is a SR or PN associated with each CG-PUSCH, in one example, if a PN is transmitted, there is a transmission or a request for transmission on the corresponding CG-PUSCH, in one example, if PN is not transmitted, there is no transmission or no request for transmission on the corresponding CG-PUSCH.

In one example, the gNB transmits/UE receives a SG (e.g., go/no-go signal) in response to the SR or PN and/or before CG-PUSCH. In one example, the SG is transmitted using channel with a format similar to PUCCH format 0. In one example, the SG is transmitted in a DCI format or MAC CE or ASN.1 message. In one example SG is transmitted a time T2 after SR/PN. In one example SG is transmitted at least T2 after SR/PN. In one example, T2 can be from start of SR or PN to start of SG as illustrated in FIG. 28. In one example, T2 can be from end of SR or PN to start of SG. In one example, T2 can be from start of SR or PN to end of SG. In one example, T2 can be from end of SR or PN to end of SG. In one example SG is transmitted a time T3 before CG-PUSCH. In one example SG is transmitted at least T3 before CG-PUSCH. In one example, T3 can be from start of SG to start of CG-PUSCH as illustrated in FIG. 28. In one example, T3 can be from end of SG to start of CG-PUSCH. In one example, T3 can be from start of SG to end of CG-PUSCH. In one example, T3 can be from end of SG to end of CG-PUSCH.

In one example, the PN/SR indicates the resource the UE may transmit the UE initiated PUSCH on. The gNB indicates to the UE whether or not to proceed with that transmission on SG, e.g., go or no-go signal. In one example, SG is transmitted in PUCCH format 0-like channel in the DL. In one example, the PUCCH format-0 like channel has one cyclic shift, the gNB transmits on the cyclic shift to indicate to UE to transmit the UE-initiated transmission in the resource indicated by PN/SR, and the gNB does not transmit on the cyclic shift to indicate to UE not to transmit the UE-initiated transmission in the resource indicated by PN/SR. In one example, the PUCCH format-0 like channel has two cyclic shifts, the gNB transmits on the first cyclic shift to indicate to UE to transmit the UE-initiated transmission in the resource indicated by PN/SR, and the gNB transmits on a second cyclic shift to indicate to UE not to transmit the UE-initiated transmission in the resource indicated by PN/SR.

In one example, SG is transmitted in a DCI format or MAC or ASN.1 message. In one example, the DCI format is UE specific DCI (or MAC CE UE specific or ASN.1 message UE specific), and indicates to the UE whether or not to transmit on the resource indicated by SR/PN. In one example, the DCI format can include a field (e.g., one-bit) to indicate whether or not to transmit on the resource indicated by SR/PN. In one example, the CRC-scrambling code of the DCI format (e.g., the UE can have two-CRC scrambling codes one indicating to proceed with transmission, and the other indicating not to proceed with transmission) can indicate whether or not the UE proceeds with the transmission on the resource indicated by SR/PN. In one example, the DCI format can include information about the MCS and/or TBS and HARQ related parameters and/or MIMO rated parameters.

In one example, the DCI format is GC-DCI (or MAC or ASN.1 message is UE group specific), the DCI (or MAC CE or ASN. 1 message) is sent to a group of UEs, i.e., the CRC of the DCI format is scrambled by a group-common RNTI. In one example, a UE is allocated a bit-field in the payload of the GC-DCI. In one example, if the bit of the allocated/corresponding field to the UE is “1” the UE proceeds with the transmission, in one example if the bit of the allocated/corresponding field to the UE is “0” the UE does not proceed with the transmission. In one example, if the bit of the allocated/corresponding field to the UE is “0” the UE proceeds with the transmission, in one example if the bit of the allocated/corresponding field to the UE is “1” the UE does not proceed with the transmission. In one example, the GC-DCI, includes a list of indices of UEs that can proceed with transmission, a UE is configured an index and if the UE is indicated that index in the GC-DCI, the UE can proceed with the transmission. In one example, the GC-DCI through a UE configured field in the payload indicates information about the MCS and/or TBS and HARQ related parameters and/or MIMO rated parameters. In one example, each UE index indicated in the DCI has information about the MCS and/or TBS and HARQ related parameters and/or MIMO rated parameters related to that UE index included in the DCI format or MAC CE or ASN.1.

In one example, the PN/SR indicates the resource the UE may transmit the UE initiated PUSCH on. In one example, the gNB indicates to the UE whether or not to proceed with that transmission on the indicated resource in SG, e.g., go or no-go signal, and if a “no-go” transmission gNB can indicate to the UE an alternate resource or no transmission. In one example, the gNB indicates to the UE the resource to transmit on (e.g., the same as the resource indicated by the UE or a different resource) or no transmission.

In one example of FIG. 28, SG is transmitted in PUCCH format 0-like channel in the DL. In one example, the PUCCH format-0 like channel has two cyclic shifts, wherein the first cyclic shift corresponds to transmission on CG-PUSCH1 of FIG. 28 and the second cyclic shift corresponds to transmission on CG-PUSCH2, and if a gNB transmits no cyclic shift corresponding to no transmission. In another example, the PUCCH format-0 like channel has two cyclic shifts, wherein the first cyclic shift corresponds to transmission on resource indicated by PN/SR of FIG. 28 and the second cyclic shift corresponds to transmission on the other resource not indicated by PN/SR, and if a gNB transmits no cyclic shift this corresponds to no transmission.

In one example, the PUCCH format-0 like channel has three cyclic shifts, wherein the first cyclic shift corresponds to transmission on CG-PUSCH1 of FIG. 28 and the second cyclic shift corresponds to transmission on CG-PUSCH2, and the third cyclic shift corresponds to no transmission. In another example, the PUCCH format-0 like channel has three cyclic shifts, wherein the first cyclic shift corresponds to transmission on resource indicated by PN/SR of FIG. 28 and the second cyclic shift corresponds to transmission on the other resource not indicated by PN/SR, and the third cyclic shift corresponds to no transmission. In one example, if there are K CG-PUSCH, the PUCCH Format-0 like channel has K cyclic shifts, with a cyclic shift corresponding to one of the K CG-PUSCHs. In one example, if there are K CG-PUSCH, the PUCCH Format-0 like channel has K+1 cyclic shifts, with a cyclic shift corresponding to one of the K+1 CG-PUSCH, and one of the K+1 cyclic shifts corresponds to no transmission.

In one example, SG is transmitted in a DCI format or MAC CE or ASN.1 message. In one example, the DCI format is UE specific DCI (or MAC CE UE specific or ASN.1 message UE specific), and indicates to the UE whether or not to transmit from the UE and the resources on which to transmit. In one example, the DCI format can include a field (e.g., one-bit) to indicate whether or not to transmit. In one example, the DCI format can include a field to indicate the resource(s) on which to transmit. In one example, the DCI format can include a field (e.g., one-bit) to indicate whether or not to transmit on the resource indicated by SR/PN. In one example, if a DCI is not transmitted by the gNB and not received by the UE, the UE does not transmit the UE initiated transmission.

In one example, the CRC-scrambling code of the DCI format (e.g., the UE can have two-CRC scrambling codes one indicating proceed with transmission, and the other indicating not to proceed with transmission) can indicate whether the UE proceeds with the transmission or not, the DCI format can indicate which resource to use. In one example, the DCI format can include information about the MCS and/or TBS and HARQ related parameters and/or MIMO rated parameters.

In one example, the DCI format is GC-DCI (or MAC or ASN. 1 message is UE group specific), the DCI (or MAC CE or ASN. 1 message) is sent to a group of UEs, i.e., the CRC of the DCI format is scrambled by a group-common RNTI. In one example, a UE is allocated with a field in the payload of the GC-DCI. In one example, the field allocated/corresponding to the UE can indicate to the UE whether or not to proceed with the transmission and resource(s) to use for the transmission. In one example, the GC-DCI, includes a list of indices of UEs that can proceed with transmission, a UE is configured an index and if the UE is indicated that index in the GC-DCI, the UE can proceed with the transmission. In one example, the GC-DCI through a UE configured field in the payload indicates information about the resource(s) to use for transmission and/or MCS and/or TBS and HARQ related parameters and/or MIMO rated parameters. In one example, each UE index indicated in the DCI has information about the resource(s) to use for transmission and/or MCS and/or TBS and HARQ related parameters and/or MIMO rated parameters related to that UE index included in the DCI format.

In one example, the PN/SR indicates whether a UE has a transmission or not for the current occasion, the UE can also indicate an amount of necessary resources. In one example, the gNB indicates to the UE whether or not to proceed with that transmission in the corresponding transmission occasion in SG, e.g., go or no-go signal, and if “go” transmission gNB can indicate to the UE a resource(s) for the transmission.

In one example of FIG. 28, SG is transmitted in PUCCH format 0-like channel in the DL. In one example, the PUCCH format-0 like channel has two cyclic shifts, wherein the first cyclic shift corresponds to transmission on CG-PUSCH1 of FIG. 28 and the second cyclic shift corresponds to transmission on CG-PUSCH2, and if a gNB transmits no cyclic shift this corresponds to no transmission. In one example, the PUCCH format-0 like channel has three cyclic shifts, wherein the first cyclic shift corresponds to transmission on CG-PUSCH1 of FIG. 28 and the second cyclic shift corresponds to transmission on CG-PUSCH2, and the third cyclic shift corresponds to no transmission. In one example, if there are K CG-PUSCH, the PUCCH Format-0 like channel has K cyclic shifts, with a cyclic shift corresponding to one of the K CG-PUSCHs. In one example, if there are K CG-PUSCH, the PUCCH Format-0 like channel has K+1 cyclic shifts, with a cyclic shift corresponding to one of the K+1 CG-PUSCH, and one of the K+1 cyclic shifts corresponds to no transmission.

In one example, SG is transmitted in a DCI format or MAC CE or ASN.1 message. In one example, the DCI format is UE specific DCI (or MAC CE UE specific or ASN.1 message UE specific), and indicates to the UE whether or not to transmit from the UE and the resources on which to transmit. In one example, the DCI format can include a field (e.g., one-bit) to indicate whether or not to transmit. In one example, the DCI format can include a field to indicate the resource(s) on which to transmit. In one example, if a DCI is not transmitted by the gNB and not received by the UE, the UE does not transmit the UE initiated transmission. In one example, the DCI format can include information about the MCS and/or TBS and HARQ related parameters and/or MIMO rated parameters.

In one example, the DCI format is GC-DCI (or MAC or ASN.1 message is UE group specific), the DCI (MAC CE or ASN.1 message) is sent to a group of UEs, i.e., the CRC of the DCI format is scrambled by a group-common RNTI. In one example, a UE is allocated a field in the payload of the GC-DCI. In one example, the field allocated/corresponding to the UE can indicate to the UE whether or not to proceed with the transmission and resource(s) to use for the transmission. In one example, the GC-DCI includes a list of indices of UEs that can proceed with transmission, a UE is configured with an index and if the UE is indicated that index in the GC-DCI, the UE can proceed with the transmission. In one example, the GC-DCI through a UE configured field in the payload indicates information about the resource(s) to use for transmission and/or MCS and/or TBS and HARQ related parameters and/or MIMO rated parameters. In one example, each UE index indicated in the DCI has information about the resource(s) to use for transmission and/or MCS and/or TBS and HARQ related parameters and/or MIMO rated parameters related to that UE index included in the DCI format.

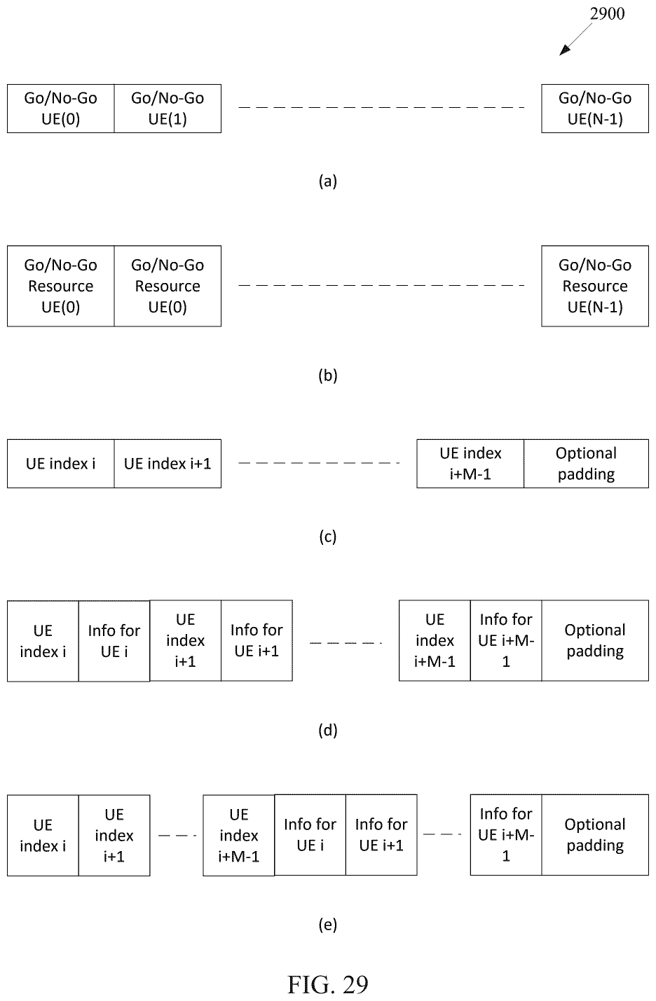

FIG. 29 illustrates an example of various GC-DCI 2900 according to embodiments of the present disclosure. An embodiment of the various GC-DCI 2900 shown in FIG. 29 is for illustration only.

FIG. 29 illustrates various examples of GC-DCI. In variant examples of this disclosure, GC-DCI in this disclosure can be replaced by MAC CE or group-common MAC CE or ASN.1 message or group common ASN.1 message, wherein the group-common MAC CE or ASN.1 message has fields similar to the GC-DCI. Group common can also include the case, the message is sent to all UEs in cell or served by gNB or TRP. In FIG. 29 (e.g., (a) as illustrated in FIG. 29), a GC-DCI includes N fields for N UE's wherein each field corresponding to a UE n, n=0, 1, . . . . N-1, indicates a go/no-go signal for the UE n. The UE n is configured the location of its corresponding field, or is configured with an index from which the UE determines its corresponding field (e.g., UE index modulo N gives index of the field of use for UE). In one example, the length of go/no-go field is 1-bit, wherein “0” can indicate to the UE to not proceed with the UE initiated transmission (e.g., no-go) and “1” can indicate to the UE to proceed with the UE-initiated transmission (e.g., go), or vice versa, i.e., “1” can indicate to the UE to not proceed with the UE initiated transmission (e.g., no-go) and “0” can indicate to the UE to proceed with the UE-initiated transmission (e.g., go).

In FIG. 29 (e.g., (b) as illustrated in FIG. 29), a GC-DCI includes N fields for N UE's wherein each field corresponding to the UE n, n=0, 1, . . . . N-1, indicates a go/no-go signal for the UE n and corresponding resource to use when applicable. The UE n is configured the location of its corresponding field, or is configured with an index from which the UE determines its corresponding field (e.g., UE index modulo N gives index of the field of use for UE). For example, if the bit-field is m bits, the bits corresponding to the UE n are from n×m to (n+1)×m−1. In one example, a special value of field indicates no transmission for the corresponding UE (e.g., the all zero value or the all one value), the remaining values of the field can indicate corresponding resources.

In one example, a bit in the field indicates transmission or no transmission for the corresponding UE, the remaining bits indicate the resource to use in case of transmission. In one example, a bit in the field indicates transmission or no-transmission on the resource indicated by the corresponding SR/PN, the remaining bits indicate an alternative resource or no transmission when the first bit indicates no transmission on the resource indicated by the corresponding SR/PN, in one example, a special value is used to indicate no transmission, in one example, if the UE is indicated the same resource as that indicated in SR/PN this indicates no transmission.

In FIG. 29 (e.g., (c) as illustrated in FIG. 29), a GC-DCI includes UE indices of UEs which can proceed with UE-initiated transmissions in respective resources of a transmission occasion. In one example, the resources as those indicated by the corresponding SR/PN. In the example of FIG. 29 (e.g., (c) as illustrated in FIG. 29) M UEs are indicated in the GC-DCI up to M_max. In one example, padding can be added to keep the size of the GC-DCI constant, for example if M varies from one occasion to the other.

In FIG. 29 (e.g., (d) as illustrated in FIG. 29), a GC-DCI includes UE indices of UEs which can proceed with UE indicated transmission in respective resources of the transmission occasion. Additional information is signaled for each UE. In one example, the additional information can include resources for corresponding UE, and/or MCS and/or TBS and/or HARQ parameters and/or MIMO parameters for corresponding transmission. In FIG. 29 (e.g., (d) as illustrated in FIG. 29), the additional information for each UE is included after corresponding index. In the example of FIG. 25 (e.g., (d) as illustrated in FIG. 29) M UEs are indicated in the GC-DCI up to M_max. In one example, padding can be added to keep the size of the GC-DCI constant, for example if M varies from one occasion to the other.

In FIG. 29 (e.g., (e) as illustrated in FIG. 29), a GC-DCI includes UE indices of UEs which can proceed with UE indicated transmission in respective resources of the transmission occasion. Additional information is signaled for each UE. In one example, the additional information can include resources for corresponding UE, and/or MCS and/or TBS and/or HARQ parameters and/or MIMO parameters for corresponding transmission. In FIG. 29 (e.g., (e) as illustrated in FIG. 29), a list of UE indices is provided followed by a list of additional information for responding UEs. In the example of FIG. 25 (e.g., (e) as illustrated in FIG. 29) M UEs are indicated in the GC-DCI up to M_max. In one example, padding can be added to keep the size of the GC-DCI constant, for example if M varies from one occasion to the other. In this disclosure, GC-DCI can also include the case, the DCI is sent to all UEs in cell or served by gNB or TRP.

In one example, if the UE transmission is not successfully decoded by the intended receiver, it can be re-transmitted. In one example, the re-transmission has an associated SR and SG and follows the mentioned examples. In one example, the re-transmission is scheduled or granted by the network. In one example the re-transmitted resources are in the second UE resources e.g., as illustrated in FIG. 16, FIG. 22, or FIG. 23. In one example the re-transmitted resources are in the third UE resources e.g., as illustrated in FIG. 22 or FIG. 23.

In one example, a UE-transmission with SR and SG follows the examples of UE-initiated transmission with pre-notification as disclosed in the present disclosure.

The present disclosure provides: (i) pre-notification signal for UE-initiated transmissions indicating resources to be used; (ii) scheduling request indicating resources for UE transmission; and (iii) scheduling grant for UE to proceed or not with transmission on indicated resources.

The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A user equipment (UE), comprising:
a transceiver configured to:
receive first information for resources related to a first transmission, and
receive second information for multiple resource configurations related to a second transmission; and
a processor operably coupled to the transceiver, the processor configured to determine a first resource configuration from the multiple resource configurations,
wherein the transceiver is further configured to:
transmit the first transmission indicating the first resource configuration of the second transmission,
transmit the second transmission,
when the second transmission is successfully decoded at a base station (BS), receive a first signal, wherein the first signal includes a first uplink (UL) grant for a third transmission, and
transmit the third transmission based on the first UL grant.

2. The UE of claim 1, wherein the transceiver is further configured to:
in response to a decoding failure of the second transmission at the BS, receive a second signal, wherein the second signal includes a second UL grant for a re-transmission of the second transmission, and
re-transmit the second transmission based on the second UL grant.

3. The UE of claim 1, wherein:
the second transmission includes a first part and a second part,
the first part indicates channel coding parameters of the second part, and
the channel coding parameters include at least one of:
a modulation coding scheme (MCS) of the second part,
a transport block (TB) size of the second part, and
a number of layers of the second part.

4. The UE of claim 1, wherein:
the first transmission includes a base sequence multiplied by a cyclic shift, and
the cyclic shift indicates the first resource configuration of the second transmission.

5. The UE of claim 1, wherein:
the transceiver is further configured to receive a second signal in response to the first transmission, and
the second signal indicates whether to proceed with the second transmission.

6. The UE of claim 5, wherein:
the second signal is a UE group common downlink control information (GC-DCI) on a physical downlink control channel (PDCCH), and
the transceiver is further configured to receive configuration information indicating a bit-field in a payload of the GC-DCI corresponding to the UE.

7. The UE of claim 1, wherein:
the transceiver is further configured to receive a second signal in response to the first transmission,
the second signal indicates a second resource configuration of the multiple resource configurations for the second transmission, and
the second transmission is based on the second resource configuration.

8. A base station (BS), comprising:
a transceiver configured to:
transmit first information for resources related to a first transmission,
transmit second information for multiple resource configurations related to a second transmission,
receive the first transmission indicating a first resource configuration of the second transmission, and
receive the second transmission based on the first resource configuration; and
a processor operably coupled to the transceiver, the processor configured to, when the second transmission is successfully decoded, determine a first uplink (UL) grant related to a third transmission,
wherein the transceiver is further configured to:
transmit a first signal, wherein the first signal includes the first UL grant, and
receive the third transmission based on the first UL grant.

9. The BS of claim 8, wherein:
the processor is further configured to, in response to a decoding failure of the second transmission, determine a second UL grant related to a re-transmission of the second transmission, and
the transceiver is further configured to:
transmit a second signal, wherein the second signal includes the second UL grant, and
receive the re-transmission of the second transmission based on the second UL grant.

10. The BS of claim 8, wherein:
the second transmission includes a first part and a second part,
the first part indicates channel coding parameters of the second part, and
the channel coding parameters include at least one of:
a modulation coding scheme (MCS) of the second part,
a transport block (TB) size of the second part, and
a number of layers of the second part.

11. The BS of claim 8, wherein:
the first transmission includes a base sequence multiplied by a cyclic shift, and
the cyclic shift indicates the first resource configuration of the second transmission.

12. The BS of claim 8, wherein:
the processor is further configured to determine, in response to the first transmission, whether to transmit the second transmission, and
the transceiver is further configured to transmit a second signal, and the second signal indicates whether to proceed with the second transmission.

13. The BS of claim 12, wherein:
the second signal is a UE group common downlink control information (GC-DCI) on a physical downlink control channel (PDCCH), and
the transceiver is further configured to transmit configuration information indicating a bit-field in a payload of the GC-DCI corresponding to the UE.

14. The BS of claim 8, wherein:
the transceiver is further configured to transmit a second signal in response to the first transmission,
the second signal indicates a second resource configuration of the multiple resource configurations for the second transmission, and
the second transmission is based on the second resource configuration.

15. A method of operating a user equipment (UE), the method comprising:
receiving first information for resources related to a first transmission;
receiving second information for multiple resource configurations related to a second transmission;
determining a first resource configuration from the multiple resource configurations;
transmitting the first transmission indicating the first resource configuration of the second transmission;
transmitting the second transmission;
when the second transmission is successfully decoded at a base station (BS), receiving a first signal, wherein the first signal includes a first uplink (UL) grant for a third transmission; and
transmitting the third transmission based on the first UL grant.

16. The method of claim 15, further comprising:
in response to a decoding failure of the second transmission at the BS, receiving a second signal, wherein the second signal includes a second UL grant for a re-transmission of the second transmission; and
re-transmitting the second transmission based on the second UL grant.

17. The method of claim 15, wherein:
the second transmission includes a first part and a second part,
the first part indicates channel coding parameters of the second part, and
the channel coding parameters include at least one of:
a modulation coding scheme (MCS) of the second part,
a transport block (TB) size of the second part, and
a number of layers of the second part.

18. The method of claim 15, wherein:
the first transmission includes a base sequence multiplied by a cyclic shift, and
the cyclic shift indicates the first resource configuration of the second transmission.

19. The method of claim 15, further comprising:
receiving a second signal in response to the first transmission,
wherein the second signal indicates whether to proceed with the second transmission.

20. The method of claim 15, further comprising:
receiving a second signal in response to the first transmission,
wherein the second signal indicates a second resource configuration of the multiple resource configurations for the second transmission, and
wherein the second transmission is based on the second resource configuration.
